(19) United States
(12) Patent Application Publication
(10) Pub. No.: US 2021/0050972 A1
(43) Pub. Date: Feb. 18, 2021

(54) TECHNIQUES FOR ACTIVATING OR DEACTIVATING SEMI-PERSISTENT CONFIGURATION FOR CHANNEL STATE INDICATOR RESOURCE SETS

(71) Applicant: Qualcomm incorporated, San Diego, CA (US)

(72) Inventors: Ruiming Zheng, Beijing (CN); Chenxi Hao, Beijing (CN); Yu Zhang, Beijing (CN)

(21) Appl. No.: 16/969,320

(22) PCT Filed: Feb. 13, 2019
(86) PCT No.: PCT/CN2019/074944

§ 371 Date: Aug. 12, 2020

(30) Foreign Application Priority Data
Feb. 15, 2018 (CN) PCT/CN2018/076910

(51) Int. Cl. H04L 5/00; H04W 72/08; H04B 7/06

(52) U.S. Cl. CPC H04L 5/0048; H04B 7/0626; H04W 72/082

(57) ABSTRACT

Techniques are described herein for activating and/or deactivating a semi-persistent configuration for one or more channel state information reference signal (CSI-RS) resource sets using a medium access control (MAC) control element (CE) and/or radio resource control (RRC) signaling. The MAC CE may include an indicator to indicate whether a semi-persistent configuration for a CSI resource set that includes one or more CSI resources is to be activated or deactivated. The MAC CE may also include identifiers for each of the CSI resource sets having the semi-persistent configuration activated or deactivated. In some cases, RRC messages may be used to communicate quasi-collocation (QCL) relationships associated with the CSI resources of the CSI resource sets. In some cases, the MAC CE may communicate at least some of or a portion of the information related to QCL relationships.

### CROSS REFERENCES

The present Application is a 371 national phase of International Patent Application No. PCT/CN2019/074944 by Zheng et al., entitled “TECHNIQUES FOR ACTIVATING OR DEACTIVATING SEMI-PERSISTENT CONFIGURATION FOR CHANNEL STATE INDICATOR RESOURCE SETS,” filed Feb. 13, 2019; and claims priority to International Patent Application No. PCT/CN2018/076910 by Zheng et. al., entitled “TECHNIQUES FOR ACTIVATING SEMI-PERSISTENT CONFIGURATION FOR CHANNEL STATE INDICATOR RESOURCE SETS,” filed Feb. 15, 2018, each of which is assigned to the assignee hereof and each of which is hereby incorporated by reference in its entirety.

### BACKGROUND

The following relates generally to wireless communication, and more specifically to techniques for activating or deactivating a semi-persistent configuration for channel state indicator resource sets.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

Some wireless communication systems may use channel state information (CSI) reporting as an indicator of channel conditions at a given time. CSI reporting may enable a base station and a UE to maintain a communication link without experiencing a radio link failure event.

### SUMMARY

The described techniques relate to improved methods, systems, devices, or apparatuses that support techniques for activating a semi-persistent configuration for channel state indicator resource sets. Generally, the described techniques provide for activating/deactivating a semi-persistent configuration for channel state information resource signal (CSI-RS) resource sets or CSI resource sets for CSI inter-cell interference measurement (CSI-IM) using a medium access control (MAC) control element (CE) and/or radio resource control (RRC) signaling. The MAC CE may include an indicator to indicate whether a semi-persistent configuration for a CSI-RS resource set or a CSI-IM resource set that includes one or more CSI-RS resources or CSI-IM resources is to be activated or deactivated. The MAC CE may also include identifiers for each of the CSI-RS resource sets or the CSI-IM resource sets having the semi-persistent configuration activated or deactivated. In some cases, RRC messages may be used to communicate quasi-collocation (QCL) relationships associated with the CSI-RS resources of the CSI-RS resource sets or the CSI-IM resources of the CSI-IM resource sets. In some cases, the MAC CE may communicate at least some or a portion of the information related to QCL relationships.

A method of wireless communication is described. The method may include receiving a MAC CE that includes an indicator for activating or deactivating a semi-persistent configuration of one or more CSI-RS resource sets, identifying a CSI-RS resource set to activate or deactivate in the semi-persistent configuration based at least in part on receiving the MAC CE, the CSI-RS resource set comprising one or more CSI-RS resources, determining one or more QCL relationships mapped to the one or more CSI-RS resources in the CSI-RS resource set, and monitoring the one or more CSI-RS resources of the CSI-RS resource set based at least in part on identifying the CSI-RS resource set and determining the one or more QCL relationships for each CSI-RS resource.

An apparatus for wireless communication is described. The apparatus may include means for receiving a MAC CE that includes an indicator for activating or deactivating a semi-persistent configuration of one or more CSI-RS resource sets, means for identifying a CSI-RS resource set to activate or deactivate in the semi-persistent configuration based at least in part on receiving the MAC CE, the CSI-RS resource set comprising one or more CSI-RS resources, means for determining one or more QCL relationships mapped to the one or more CSI-RS resources in the CSI-RS resource set, and means for monitoring the one or more CSI-RS resources of the CSI-RS resource set based at least in part on identifying the CSI-RS resource set and determining the one or more QCL relationships for each CSI-RS resource.

Another apparatus for wireless communication is described. The apparatus may include a processor, memory in electronic communication with the processor, and instructions stored in the memory. The instructions may be operable to cause the processor to receive a MAC CE that includes an indicator for activating or deactivating a semi-persistent configuration of one or more CSI-RS resource sets, identify a CSI-RS resource set to activate or deactivate in the semi-persistent configuration based at least in part on receiving the MAC CE, the CSI-RS resource set comprising one or more CSI-RS resources, determine one or more QCL relationships mapped to the one or more CSI-RS resources in the CSI-RS resource set, and monitor the one or more CSI-RS resources of the CSI-RS resource set based at least in part on identifying the CSI-RS resource set and determining the one or more QCL relationships for each CSI-RS resource.

A non-transitory computer-readable medium for wireless communication is described. The non-transitory computer-readable medium may include instructions operable to cause a processor to receive a MAC CE that includes an indicator for activating or deactivating a semi-persistent configuration of one or more CSI-RS resource sets, identify a CSI-RS resource set to activate or deactivate in the semi-persistent configuration based at least in part on receiving the MAC CE, the CSI-RS resource set comprising one or more CSI-RS resources, determine one or more QCL relationships mapped to the one or more CSI-RS resources in the CSI-RS resource set, and monitor the one or more CSI-RS resources of the CSI-RS resource set based at least in part on identifying the CSI-RS resource set and determining the one or more QCL relationships for each CSI-RS resource.

In some examples of the method, apparatus, and non-transitory computer-readable medium described above, the MAC CE includes an identifier for the CSI-RS resource set.

Some examples of the method, apparatus, and non-transitory computer-readable medium described above may further include processes, features, means, or instructions for receiving an RRC configuration message that includes the one or more QCL relationships for each of the one or more CSI-RS resources, wherein determining the one or more QCL relationships may be based at least in part on receiving the RRC configuration message.

In some examples of the method, apparatus, and non-transitory computer-readable medium described above, the RRC configuration message includes at least one QCL list that includes the one or more QCL relationships mapped to the one or more CSI-RS resources of the CSI-RS resource set.

Some examples of the method, apparatus, and non-transitory computer-readable medium described above may further include processes, features, means, or instructions for identifying a QCL list identifier in the MAC CE, the QCL list identifier specifying a QCL list associated with the CSI-RS resource set activated or deactivated in the semi-persistent configuration, wherein determining the one or more QCL relationships may be based at least in part on identifying the QCL list identifier in the MAC CE.

Some examples of the method, apparatus, and non-transitory computer-readable medium described above may further include processes, features, means, or instructions for receiving an RRC configuration message that includes a plurality of QCL lists that includes the QCL list identified in the MAC CE, each list comprising a mapping of QCL relationships to CSI-RS resources, wherein determining the one or more QCL relationships may be based at least in part on receiving the RRC configuration message.

In some examples of the method, apparatus, and non-transitory computer-readable medium described above, the MAC CE includes the one or more QCL relationships for the one or more CSI-RS resources of the CSI-RS resource set that may be activated or deactivated in the semi-persistent configuration, wherein determining the one or more QCL relationships may be based at least in part on receiving the MAC CE.

In some examples of the method, apparatus, and non-transitory computer-readable medium described above, the MAC CE may have a fixed size and includes a first identifier for one CSI-RS resource set.

In some examples of the method, apparatus, and non-transitory computer-readable medium described above, the MAC CE that may have the fixed size includes a second identifier for one CSI-IM resource set.

In some examples of the method, apparatus, and non-transitory computer-readable medium described above, the MAC CE may have a variable size and includes one or more first identifiers for one or more CSI-RS resource sets.

In some examples of the method, apparatus, and non-transitory computer-readable medium described above, the MAC CE that may have the variable size includes a second identifier for one CSI-IM resource set.

Some examples of the method, apparatus, and non-transitory computer-readable medium described above may further include processes, features, means, or instructions for determining whether the MAC CE includes an identifier for a CSI-IM resource set based at least in part on a second indicator in the MAC CE that specifies whether the MAC CE includes the identifier for the CSI-IM resource set.

In some examples of the method, apparatus, and non-transitory computer-readable medium described above, the second indicator that specifies whether the MAC CE includes the identifier for the CSI-IM resource set includes one bit of the MAC CE.

In some examples of the method, apparatus, and non-transitory computer-readable medium described above, the indicator that activates or deactivates the semi-persistent configuration includes one bit of the MAC CE.

In some examples of the method, apparatus, and non-transitory computer-readable medium described above, the MAC CE includes an identifier for a CSI-RS resource set for channel measurement and an identifier for a CSI-RS for intra-cell interference measurement resource set, wherein the CSI-RS resource set for intra-cell interference measurement may be monitored using spatial QCL relationships associated with the CSI-RS resource set for channel measurement and other QCL relationships associated with the CSI-RS resource set for intra-cell interference measurement.

Some examples of the method, apparatus, and non-transitory computer-readable medium described above may further include processes, features, means, or instructions for receiving a second MAC CE that includes a second indicator that activates or deactivates the semi-persistent configuration of a CSI-IM resource set, wherein monitoring the one or more CSI-RS resources may be based at least in part on receiving the second MAC CE.

In some examples of the method, apparatus, and non-transitory computer-readable medium described above, the MAC CE includes an identifier for a CSI-RS resource set for channel measurement (CM), an identifier for a CSI-IM, one or more identifiers for one or more CSI-RS resource sets for intra-cell IM, or a combination thereof.

A method of wireless communication is described. The method may include identifying a CSI-RS resource set to activate or deactivate in a semi-persistent configuration, the CSI-RS resource set comprising one or more CSI-RS resources, determining one or more QCL relationships for the one or more CSI-RS resources in the CSI-RS resource set, and transmitting a MAC CE that includes an indicator for activating or deactivating the semi-persistent configuration of the CSI-RS resource set at a UE.

An apparatus for wireless communication is described. The apparatus may include means for identifying a CSI-RS resource set to activate or deactivate in a semi-persistent configuration, the CSI-RS resource set comprising one or more CSI-RS resources, means for determining one or more QCL relationships for the one or more CSI-RS resources in the CSI-RS resource set, and means for transmitting a MAC CE that includes an indicator for activating or deactivating the semi-persistent configuration of the CSI-RS resource set at a UE.

Another apparatus for wireless communication is described. The apparatus may include a processor, memory in electronic communication with the processor, and instructions stored in the memory. The instructions may be operable to cause the processor to identify a CSI-RS resource set to activate or deactivate in a semi-persistent configuration, the CSI-RS resource set comprising one or more CSI-RS resources, determine one or more QCL relationships for the one or more CSI-RS resources in the CSI-RS resource set, and transmit a MAC CE that includes an indicator for activating or deactivating the semi-persistent configuration of the CSI-RS resource set at a UE.

A non-transitory computer-readable medium for wireless communication is described. The non-transitory computer-readable medium may include instructions operable to cause a processor to identify a CSI-RS resource set to activate or deactivate in a semi-persistent configuration, the CSI-RS resource set comprising one or more CSI-RS resources, determine one or more QCL relationships for the one or more CSI-RS resources in the CSI-RS resource set, and transmit a MAC CE that includes an indicator for activating or deactivating the semi-persistent configuration of the CSI-RS resource set at a UE.

In some examples of the method, apparatus, and non-transitory computer-readable medium described above, the MAC CE includes an identifier for the CSI-RS resource set.

Some examples of the method, apparatus, and non-transitory computer-readable medium described above may further include processes, features, means, or instructions for transmitting an RRC configuration message that includes the one or more QCL relationships for each of the one or more CSI-RS resources.

In some examples of the method, apparatus, and non-transitory computer-readable medium described above, the RRC configuration message includes at least one QCL list that includes the one or more QCL relationships mapped to the one or more CSI-RS resources of the CSI-RS resource set.

Some examples of the method, apparatus, and non-transitory computer-readable medium described above may further include processes, features, means, or instructions for identifying a QCL list identifier of the one or more QCL relationships, the QCL list identifier specifying a QCL list associated with the CSI-RS resource set that may be activated or deactivated in the semi-persistent configuration, wherein the MAC CE includes the QCL list identifier.

Some examples of the method, apparatus, and non-transitory computer-readable medium described above may further include processes, features, means, or instructions for transmitting an RRC configuration message that includes a plurality of QCL lists that includes the QCL list identified in the MAC CE, each list comprising a mapping of QCL relationships to CSI-RS resources.

In some examples of the method, apparatus, and non-transitory computer-readable medium described above, the MAC CE includes the one or more QCL relationships for the one or more CSI-RS resources of the CSI-RS resource set that may be activated or deactivated in the semi-persistent configuration.

In some examples of the method, apparatus, and non-transitory computer-readable medium described above, the MAC CE may have a fixed size and includes a first identifier for one CSI-RS resource set.

In some examples of the method, apparatus, and non-transitory computer-readable medium described above, the MAC CE that may have the fixed size includes a second identifier for one CSI-IM resource set.

In some examples of the method, apparatus, and non-transitory computer-readable medium described above, the MAC CE may have a variable size and includes one or more first identifiers for one or more CSI-RS resource sets.

In some examples of the method, apparatus, and non-transitory computer-readable medium described above, the MAC CE that may have the variable size includes a second identifier for one CSI-IM resource set.

In some examples of the method, apparatus, and non-transitory computer-readable medium described above, the MAC CE includes a second indicator that specifies whether the MAC CE includes an identifier for a CSI-IM resource set.

In some examples of the method, apparatus, and non-transitory computer-readable medium described above, the second indicator that specifies whether the MAC CE includes the identifier for the CSI-IM resource set includes one bit of the MAC CE.

In some examples of the method, apparatus, and non-transitory computer-readable medium described above, the indicator that activates or deactivates the semi-persistent configuration includes one bit of the MAC CE.

In some examples of the method, apparatus, and non-transitory computer-readable medium described above, the MAC CE include an identifier for a CSI-RS resource set for channel measurement and an identifier for a CSI-RS for intra-cell interference measurement resource set, wherein the CSI-RS resource set for intra-cell interference measurement may be monitored using spatial QCL relationships associated with the CSI-RS resource set for channel measurement and other QCL relationships associated with the CSI-RS resource set for intra-cell interference measurement.

Some examples of the method, apparatus, and non-transitory computer-readable medium described above may further include processes, features, means, or instructions for transmitting a second MAC CE that includes a second indicator that activates or deactivates the semi-persistent configuration of a CSI-IM resource set.

In some examples of the method, apparatus, and non-transitory computer-readable medium described above, the MAC CE includes an identifier for a CSI-RS resource set for CM, an identifier for a CSI-IM, one or more identifiers for one or more CSI-RS resource sets for IM, or a combination thereof.

### BRIEF DESCRIPTION OF THE DRAWINGS

FIGS. 1 and 2 illustrate examples of a wireless communications system that supports techniques for activating or deactivating a semi-persistent configuration for channel state indicator resource sets in accordance with aspects of the present disclosure.

FIG. 3 illustrates an example of a block diagram showing a relationship between a CSI-RS resource set or a CSI-IM resource set and QCL relationships that supports techniques for activating or deactivating a semi-persistent configuration for channel state indicator resource sets in accordance with aspects of the present disclosure.

FIG. 4 illustrates an example of a block diagram showing CSI reporting and CSI resource structure that supports techniques for activating or deactivating a semi-persistent configuration for channel state indicator resource sets in accordance with aspects of the present disclosure.

FIG. 5 illustrates an example of a communication scheme that supports techniques for activating or deactivating a semi-persistent configuration for channel state indicator resource sets in accordance with aspects of the present disclosure.

FIGS. 6 through 10 illustrate examples of a MAC CE that supports techniques for activating or deactivating a semi-persistent configuration for channel state indicator resource sets in accordance with aspects of the present disclosure.

FIGS. 11 through 13 show block diagrams of a device that supports techniques for activating or deactivating a semi-persistent configuration for channel state indicator resource sets in accordance with aspects of the present disclosure.

FIG. 14 illustrates a block diagram of a system including a UE that supports techniques for activating or deactivating a semi-persistent configuration for channel state indicator resource sets in accordance with aspects of the present disclosure.

FIGS. 15 through 17 show block diagrams of a device that supports techniques for activating or deactivating a semi-persistent configuration for channel state indicator resource sets in accordance with aspects of the present disclosure.

FIG. 18 illustrates a block diagram of a system including a base station that supports techniques for activating or deactivating a semi-persistent configuration for channel state indicator resource sets in accordance with aspects of the present disclosure.

FIGS. 19 through 24 illustrate methods for techniques for activating or deactivating a semi-persistent configuration for channel state indicator resource sets in accordance with aspects of the present disclosure.

### DETAILED DESCRIPTION

Some wireless communication systems may use channel state information (CSI) reporting to indicate conditions of a channel of an active communication link between devices, such as a base station and a user equipment (UE). Various settings for CSI reporting and CSI resources may be altered to improve CSI reporting in different contexts. For example, the base station and the UE may use different types of signaling to communicate the changes in the different settings for CSI reporting.

Techniques are described herein for activating/deactivating a semi-persistent configuration for CSI reference signal (CSI-RS) resource sets or CSI resource sets for CSI inter-cell interference measurement (CSI-IM) using a medium access control (MAC) control element (CE) and/or radio resource control (RRC) signaling. The MAC CE may include an indicator to indicate whether a semi-persistent configuration for a CSI-RS resource set (e.g., that includes one or more CSI-RS resources) or a CSI-IM resource (e.g., that includes one or more CSI-IM resources) is to be activated or deactivated. Thus, the UE may activate or deactivate the CSI-RS resource set in the semi-persistent configuration based in part on the indicator. The MAC CE may also include one or more identifiers for each of the CSI-RS resource sets or CSI-IM resource sets having the semi-persistent configuration that is activated or deactivated. In some cases, RRC messages may be used to communicate quasi-collocation (QCL) relationships associated with the CSI-RS resources of the CSI-RS resource sets or the CSI-IM resources of the CSI-IM resource sets. In some cases, the MAC CE may communicate at least some of the information related to QCL relationships.

Aspects of the disclosure are initially described in the context of a wireless communications system. Aspects of the disclosure are illustrated by and described with reference to block diagrams, communication schemes, and MAC CEs. Aspects of the disclosure are further illustrated by and described with reference to apparatus diagrams, system diagrams, and flowcharts that relate to techniques for activating or deactivating one or more semi-persistent configurations for channel state indicator resource sets.

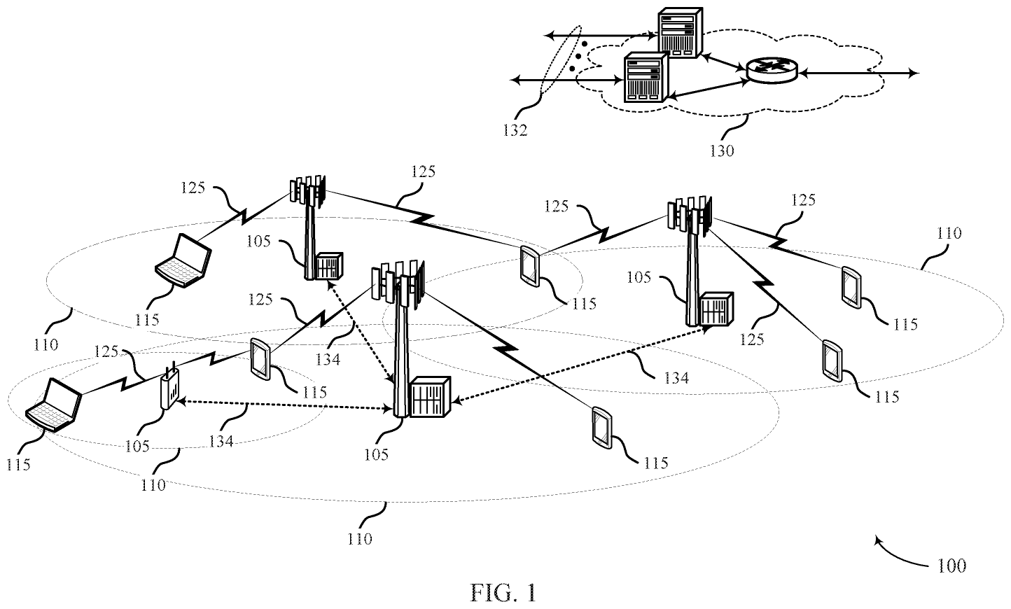

FIG. 1 illustrates an example of a wireless communications system 100 that supports techniques for activating or deactivating a semi-persistent configuration for channel state indicator resource sets in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs that can support simultaneous communications via carriers associated with more than one different carrier bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

To activate or deactivate one or more semi-persistent configurations for CSI reporting, a base station 105 may signal an indicator, for example, using a MAC CE. Various examples of types of signaling may be used to activate or deactivate semi-persistent configurations of CSI-RS resources or CSI-IM resources. In some cases, the MAC CE may include both the indicator (or indicators) for activating/deactivating CSI-RS resources or CSI-IM resources and QCL relationships. In some cases, RRC signaling may be used to communicate some or all of the information related to QCL relationships.

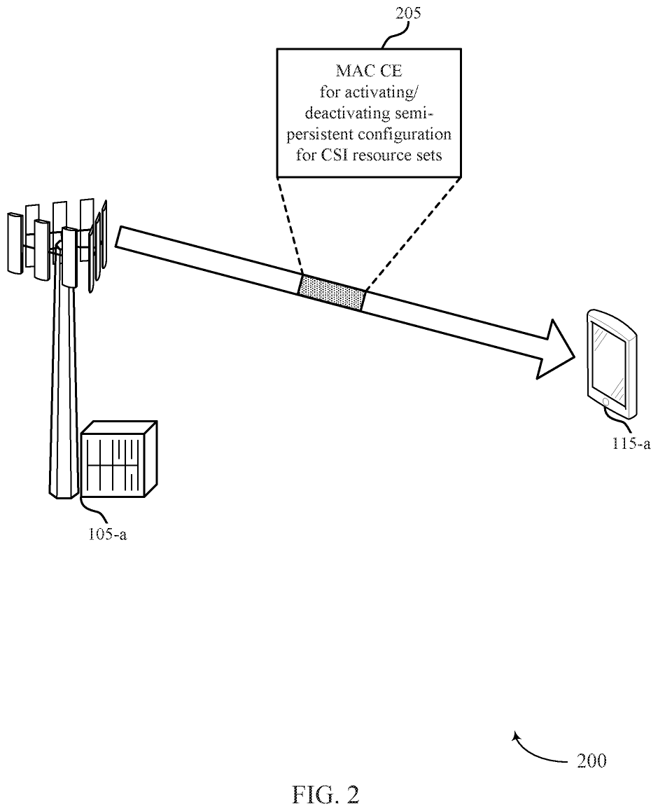

FIG. 2 illustrates an example of a wireless communications system 200 that supports techniques for activating or deactivating a semi-persistent configuration for channel state indicator resource sets in accordance with various aspects of the present disclosure. The wireless communications system 200 may include a base station 105-a and a UE 115-a, which may be examples of a base station 105 or a UE 115 described with reference to FIG. 1. The wireless communications system 200 illustrates using a MAC CE 205 to activate/deactivate a semi-persistent configuration for CSI resource sets.

In some wireless communications systems, the network (e.g., base station 105-a) may control the time resources and the frequency resources that may be used by the UE 115-a to report CSI. CSI may include of channel quality indicator (CQI), precoding matrix indicator (PMI), CSI-RS resource indicator (CRI), strongest layer indication (SLI), rank indication (RI), and/or and L1-RSRP. When controlling the communication resources used to report CSI, the base station 105-a may control a number of different variables. For example, the base station 105-a may control whether the CSI reporting is periodic, semi-persistent, or aperiodic (e.g., on-demand). The base station 105-a may also control whether the CSI resources are in a periodic configuration, a semi-persistent configuration, or an aperiodic configuration.

Techniques are provided herein for activating/deactivating a semi-persistent configuration for CSI resources using a MAC CE 205 and/or RRC signaling, in some cases. In some instances, using the MAC CE 205 to activate/deactivate the semi-persistent configuration for the CSI resources may be based on the CSI reporting already being in a semi-persistent configuration. Various structures of the MAC CE 205 for activating/deactivating the semi-persistent configurations of CSI resources are described. In some cases, one or more RRC configuration messages may be used to communicate QCL relationships associated with the CSI resources.

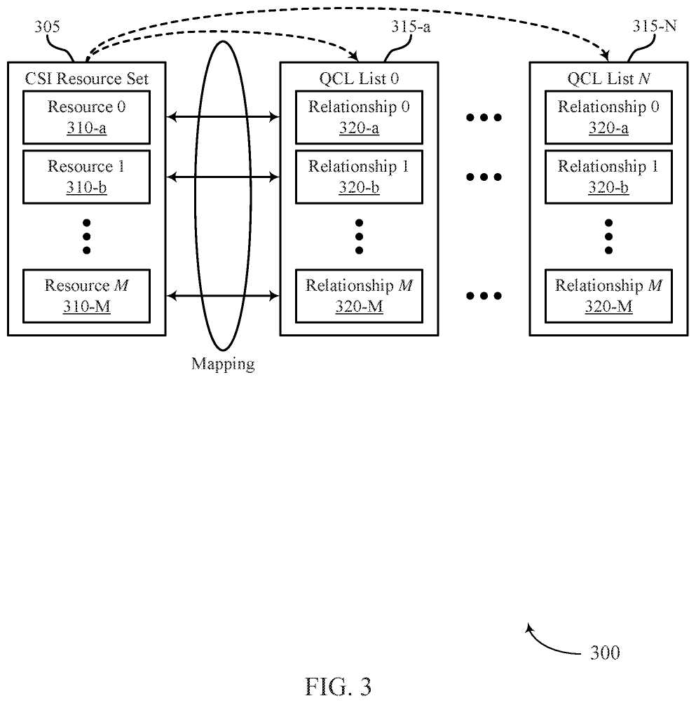

FIG. 3 illustrates an example of a block diagram 300 showing the relationship between a CSI resource set 305 and QCL relationships 320 that supports techniques for activating or deactivating a semi-persistent configuration for channel state indicator resource sets in accordance with various aspects of the present disclosure. The CSI resource set 305 may be an example of a CSI-RS resource set that includes CSI-RS resources or a CSI-IM resource set that includes CSI-IM resources. As used herein, the term CSI resource set may refer to either a CSI-RS resource set or a CSI-IM resource set and the term CSI resource may refer to either a CSI-RS resource or a CSI-IM resource. The block diagram 300 may be implemented using the wireless communications systems 100 and 200 described with reference to FIGS. 1 and 2.

The CSI resource set 305 may include one or more CSI resources 310. The CSI resource set 305 may be an example of a CSI-RS resource set or a CSI resource set for CSI-IM. The CSI resource set 305 may be a grouping of CSI resources 310 that are configured similarly. For example, every CSI resource 310 in the CSI resource set 305 may be configured for channel measurement, intra-cell interference measurement, or inter-cell interference management. Semi-persistent configurations of CSI resources 310 may be determined on a CSI resource set basis. Meaning that semi-persistent configurations are activated and/or deactivated at the CSI resource set level and not at the individual CSI resource level. The MAC CE 205 may be configured to identify one or more CSI resource set that should have a semi-persistent configuration activated and/or deactivated. CSI resources 310 may be used for the communication of reference signals and/or other signals used for measuring and/or reporting CSI.

In some wireless communications systems, a QCL relationship 320 may include one or more QCL parameters associated with each CSI resource 310 in the CSI resource set 305. A QCL relationship 320 may indicate information related to the communication link for a given CSI resource 310. For example, the QCL relationship may include spatial information about the direction of a directional beam (or listening configuration) a width of a directional beam (or listening configuration), information about Doppler effects associated with the communication link, information about delay associated with the communication link, timing associated with the communication link, or various combinations thereof.

In some cases, QCL relationships 320 may be grouped into one or more QCL lists 315. A QCL list 315 include a grouping of QCL relationships 320 that may be mapped to a grouping of CSI resources 310 grouped in a CSI resource set 305. Using QCL lists 315 may simplify signaling and the mapping of QCL relationships 320 with CSI resources 310. For example, a CSI resource set 305 may be mapped to a predetermined QCL list 315 and then each CSI resource 310 in the CSI resource set 305 may be mapped to one or more QCL relationships 320 in the QCL list 315. In some cases, the mapping between CSI resources 310 and QCL relationships 320 may be done a predetermined manner. In some cases, there may be a one-to-one mapping of a CSI resource 310 to a single QCL relationship 320. In some cases, a CSI resource 310 may be mapped to at least portions of multiple QCL relationships 320.

In order to measure and report CSI, the UE 115-a may use the QCL relationships to configure directional transmission beams and/or directional listening configurations in a wireless communication system that supports millimeter wave (mmW) communication. In some cases, the MAC CE 205 may be configured to communicate QCL relationship information. For example, the MAC CE 205 may be configured to communicate identifiers for QCL lists 315. In other examples, the MAC CE 205 may be configured to communicate the QCL relationships 320. In yet other examples, the MAC CE 205 may not communicate QCL information, which instead may be communicated using RRC signaling.

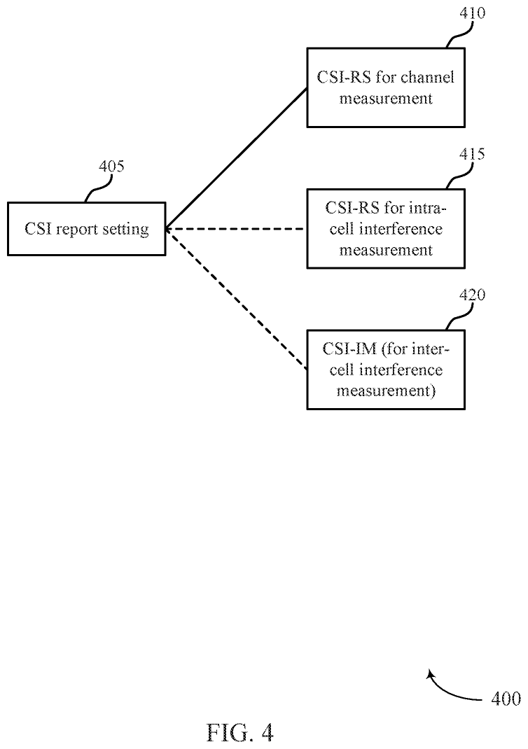

FIG. 4 illustrates an example of a block diagram 400 showing CSI reporting and CSI resource structure that supports techniques for activating or deactivating a semi-persistent configuration for channel state indicator resource sets in accordance with various aspects of the present disclosure. The CSI reporting and CSI resource structure may be organized in a sequential manner. A CSI reporting setting 405 may be independently configured from the CSI resource settings 410, 415, 420. In some cases, up to three unique types of CSI resource settings may be linked to a single CSI reporting setting 405. For example, the CSI reporting setting 405 may be associated with a CSI-RS resource setting 410 for channel measurement. Optionally, CSI reporting setting 405 may be associated with one or more CSI-RS resource settings 415 for intra-cell interference or a CSI-IM resource setting 420. Each resource setting 410, 415, 420 may be associated with one or more CSI resource sets. In some cases, each resource setting 410, 415, 420 is associated with a single CSI resource set.

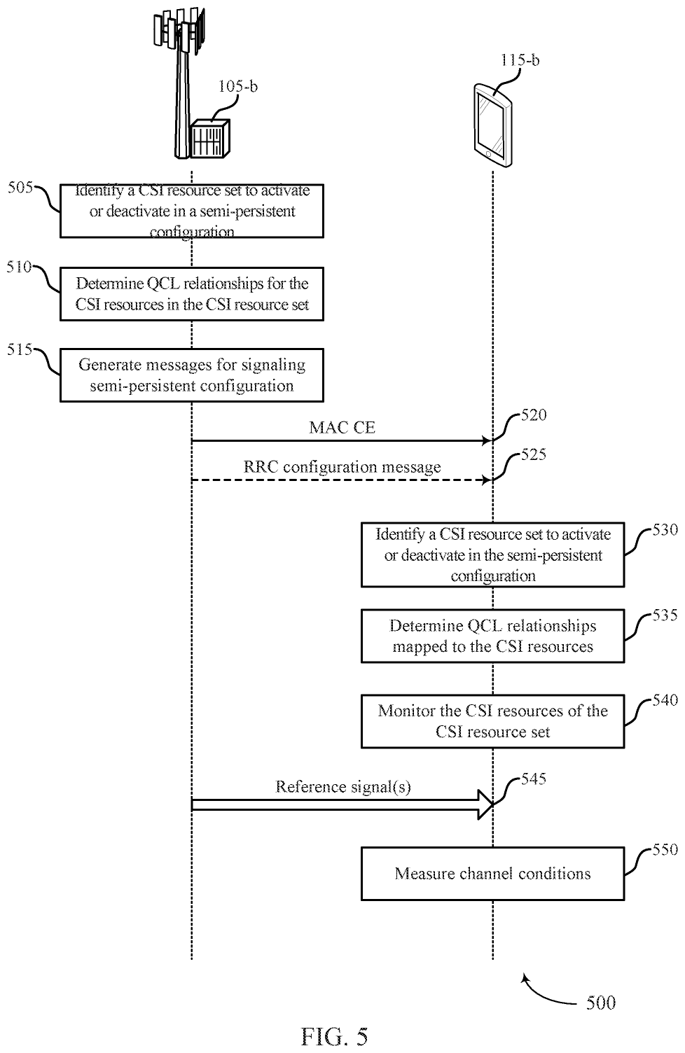

FIG. 5 illustrates an example of a communication scheme 500 that supports techniques for activating or deactivating a semi-persistent configuration for channel state indicator resource sets in accordance with various aspects of the present disclosure. The communication scheme 500 may be implemented using one or more of the wireless communications systems 100 or 200 described with reference to FIGS. 1 and 2. The communication scheme 500 illustrates functions and communications that may occur as part of using a MAC CE to activate/deactivate semi-persistent configurations for CSI resource sets including CSI-RS resources sets and CSI-IM resource sets. The communication scheme 500 includes functions and communications implemented by a base station 105-b and a UE 115-b in the context of a downlink beam pair link, which may be examples of the base stations 105 and UEs 115 described with reference to FIGS. 1 and 2.

At 505, the base station 105-b may identify a CSI resource set to activate or deactivate in a semi-persistent configuration. For example, the base station 105-b may identify one or more CSI-RS resource sets or one or more CSI-IM resource sets, as the case may be. As used herein, the term CSI resource set may refer to either a CSI-RS resource set or a CSI-IM resource set and the term CSI resource may refer to either a CSI-RS resource or a CSI-IM resource. The base station 105-b may make this determination based on the CSI reporting setting being a semi-persistent configuration or an aperiodic configuration. The base station 105-b may activate or deactivate a semi-persistent configuration for CSI resource sets to limit the amount of communication resources used for CSI report.

At 510, the base station 105-c may determine QCL relationships for the CSI resources (e.g., CSI-RS resources or CSI-IM resources) in the CSI resource set. The QCL relationships may indicate directional transmission beams and/or directional listening configurations in a wireless communication system that supports mmW communication. For example, the QCL relationships may indicate spatial information about the direction of a directional beam (or listening configuration) a width of a directional beam (or listening configuration), information about Doppler effects associated with the communication link, information about delay associated with the communication link, timing associated with the communication link, or various combinations thereof.

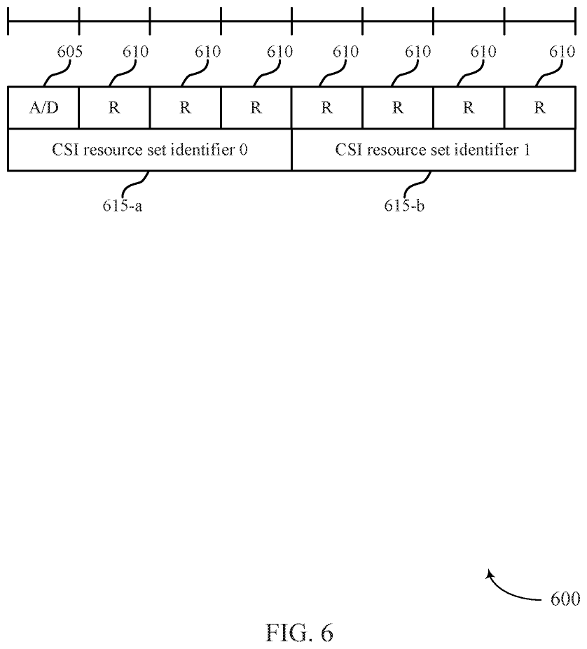

At 515, the base station 105-b may generate one or more messages for signaling the activation/deactivation of semi-persistent configurations for CSI resource sets (e.g., CSI-RS resource sets or CSI-IM resource sets). The activation/deactivation of semi-persistent configurations for CSI resources sets may be communicated by a MAC CE 520. The MAC CE 520 may be an example of the MAC CE 205 described with reference to FIG. 2. The QCL relationships associated with the CSI resource set may be communicated by the MAC CE 520 or by a RRC configuration message 525. As is described in more detail with reference to FIGS. 6-9, there are a variety of different options for signaling the activation/deactivation of semi-persistent configurations and/or the QCL relationships associated with CSI resource sets. In some examples, the MAC CE 520 may include the indicator for activating/deactivating the semi-persistent configurations and the RRC configuration message 525 may include the information related to the QCL relationships. In some examples, the MAC CE 520 may include the indicator for activating/deactivating the semi-persistent configurations and an identifier for a QCL list and the RRC configuration message 525 may include the information related to the QCL lists and the QCL relationships. In some examples, the MAC CE 520 may include the indicator for activating/deactivating the semi-persistent configurations and the QCL relationships associated with CSI resource sets.

At 530, the UE 115-b may identify a CSI resource set (e.g., CSI-RS resource set or CSI-IM resource set) to activate or deactivate in a semi-persistent configuration based on receiving the MAC CE 520. The UE 115-b may identify a CSI resource set using an identifier of the CSI resource set in the MAC CE 520 and may determine whether the CSI resource set is to be activated or deactivated based on an activation/deactivation indicator included in the MAC CE 520.

At 535, the UE 115-b may determine QCL relationships mapped to the CSI resources of the CSI resource set (e.g., CSI-RS resource set or CSI-IM resource set). The UE 115-b may determine these QCL relationships based on receiving the MAC CE 520, receiving the RRC configuration message 525, or receiving both messages.

At 540, the UE 115-b may monitor the CSI resources (e.g., CSI-RS resources or CSI-IM resources) of the CSI resource set (e.g., CSI-RS resource set or CSI-IM resource set) based on receiving the MAC CE 520 and/or receiving the RRC configuration message 525. The UE 115-b may configure one or more listening configurations based on whether the CSI resources are in a semi-persistent configuration and/or the QCL relationships associated with the CSI resources.

The base station 105-b may transmit one or more reference signal(s) 545 based on transmitting the MAC CE 520 and/or the RRC configuration message 525. The reference signals 545 may be used for CSI reporting. At block 550, the UE 115-b may measure channel conditions based on receiving the reference signals 545. The UE 115-b may use the activation/deactivation indicator and the QCL relationships to monitor for the reference signals 545.

FIG. 6 illustrates an example of a MAC CE 600 that supports techniques for activating or deactivating a semi-persistent configuration for channel state indicator resource sets in accordance with various aspects of the present disclosure. The MAC CE 600 represents an example of a MAC CE structure and signaling scheme that may be used to activate or deactivate semi-persistent configurations for CSI resource sets (e.g., CSI-RS resource sets or CSI-IM resource sets). In some cases, the MAC CE 600 may be an example of the MAC CE 205, 520 described with reference to FIGS. 2 and 5.

In the signaling scheme represented by the MAC CE 600, the RRC configuration message may provide the QCL relationships and the associated mapping to the CSI resources and the MAC CE 600 may be configured to activate/deactivate the semi-persistent configurations for the CSI resource sets. The MAC CE 600 may include an indicator 605, one or more reserved bits 610, and one or more CSI resource set identifiers 615. The indicator 605 may be configured to indicate whether the CSI resource sets included in the MAC CE 600 are to be activated or deactivated in a semi-persistent configuration. In some cases, the indicator 605 may be a single bit where one logic value (e.g., 1 or 0) indicates activation and the other logic value (e.g., 0 or 1) indicates deactivation. In some cases, the indicator 605 may be more than one bit. In some cases, MAC CE 600 may include a single indicator 605 for the entire MAC CE 600. In some cases, the MAC CE 600 may include more than one indicator 605, where each indicator 605 may be mapped to one or more CSI resource set identifiers 615.

The CSI resource set identifier 615 may be configured to identify CSI-RM resource sets or CSI-IM resource sets that should have a semi-persistent configuration either activated or deactivated. The CSI resource set identifiers 615 may be configured to identify any type of CSI resource set including CSI-RM resource sets or CSI-IM resource sets. As used herein, the term CSI resource set may refer to either a CSI-RS resource set or a CSI-IM resource set and the term CSI resource may refer to either a CSI-RS resource or a CSI-IM resource. For example, the CSI resource set identifier 615 may identify a CSI-RS resource set for channel measurement, a CSI-RS resource set for intra-cell interference measurement, or a CSI-IM resource set (that is for inter-cell interference measurement).

In some cases, the MAC CE 600 may be a fixed size. In such cases, the MAC CE 600 may include a first identifier for one CSI-RS resource set and/or a second identifier for one CSI-IM resource set. When the MAC CE 600 is a fixed size, the MAC CE 600 may include QCL relationship information or it may not.

In some cases, the MAC CE 600 may be a variable size. In such cases, the MAC CE 600 may include identifiers of one or more CSI-RS resource sets and identifiers of one or more CSI-IM resource sets. When the MAC CE 600 is a variable size, the MAC CE 600 may include QCL relationship information or it may not.

When using the MAC CE 600, the RRC configuration message (e.g., RRC configuration message 525) may be configured to communicate the QCL relationships and/or QCL lists associated with the CSI resource sets indicated in the MAC CE 600. The RRC configuration message may include a mapping of the CSI resources of the MAC CE 600 to QCL relationships. The mapping may be a mapping to a predetermined QCL list or the mapping may indicate relationships between individual CSI resources and individual QCL relationships.

When using this type of signaling scheme, the QCL relationships may be changed using the RRC configuration message without having to communicate MAC CE that indicates whether the semi-persistent configurations are activated/deactivated. In some cases, the RRC configuration message may have more latency than the MAC CE 600 so that the QCL relationship data may delay configuring resources for the CSI reporting until both the MAC CE 600 and the RRC configuration message are received.

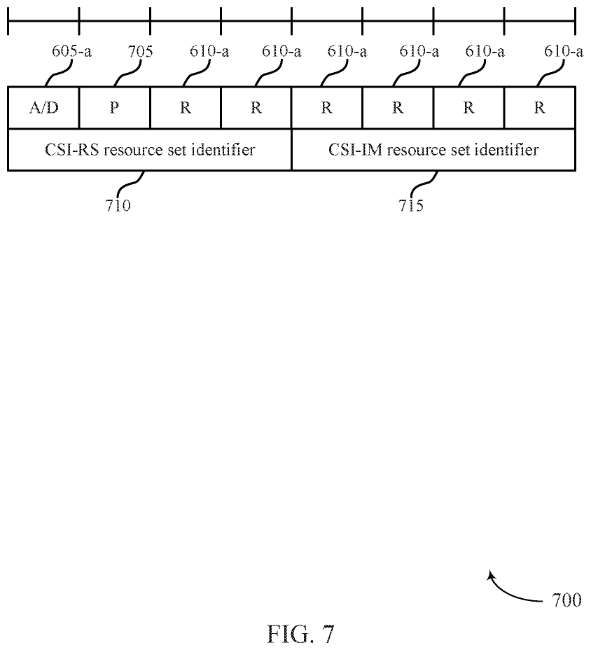

FIG. 7 illustrates an example of a MAC CE 700 that supports techniques for activating or deactivating a semi-persistent configuration for channel state indicator resource sets in accordance with various aspects of the present disclosure. The MAC CE 700 represents an example of a MAC CE structure and signaling scheme that may be used to activate or deactivate semi-persistent configurations for CSI resource sets (e.g., CSI-RS resource sets or CSI-IM resource sets). In some cases, the MAC CE 700 may be an example of the MAC CE 205, 520, 600 described with reference to FIGS. 2, 5, and 6.

The MAC CE 700 is similarly embodied as the MAC CE 600 for a number of different features. For example, the MAC CE 700 includes an indicator 605-a for activating/deactivating semi-persistent configurations and reserved bits 610-a. The MAC CE 700 may also be capable of having a fixed length or a variable length and communicating information about CSI resource sets of many different types.

The MAC CE 700 includes a CSI-IM indicator 705 to indicate whether the MAC CE 700 includes information about a CSI-IM resource set. The MAC CE 700 may include one or more CSI-RS resource set identifiers 710 and a CSI-IM resource set identifier 715. In some cases, if the CSI-IM indicator 705 indicates that the MAC CE 700 includes the CSI-IM resource set identifier 715, the UE 115-b may interpret the data in certain fields of the MAC CE 700 differently than if the CSI-IM indicator is negative. If the CSI-IM indicator 705 indicates that the MAC CE 700 includes the CSI-IM resource set identifier 715, the UE 115-b may interpret a certain field of the MAC CE 700 as a CSI-IM resource set identifier 715. In some cases, if the CSI-IM indicator 705 indicates that the MAC CE 700 does not include the CSI-IM resource set identifier 715, the UE 115-b may interpret a certain field of the MAC CE 700 as a CSI-RS resource set identifier 710. In some cases, if the CSI-IM indicator 705 indicates that the MAC CE 700 does not include the CSI-IM resource set identifier 715, the UE 115-b may interpret a certain field of the MAC CE 700 as not including any relevant information.

The MAC CE 700 may be used in the same type of signaling scheme as the MAC CE 600 where RRC configuration message is used to communicate information about the QCL relationships. In some cases, the MAC CE 700 may be an alternative implementation from the MAC CE 600 that includes the CSI-IM indicator 705. In some cases, the indicator 705 may be a single bit where one logic value (e.g., 1 or 0) indicates that a CSI-IM resource set is present and the other logic value (e.g., 0 or 1) indicates that a CSI-IM resource set is not present. In some cases, the indicator 705 may be more than one bit. The MAC CE 700 may include a single indicator 705 for the entire MAC CE 700.

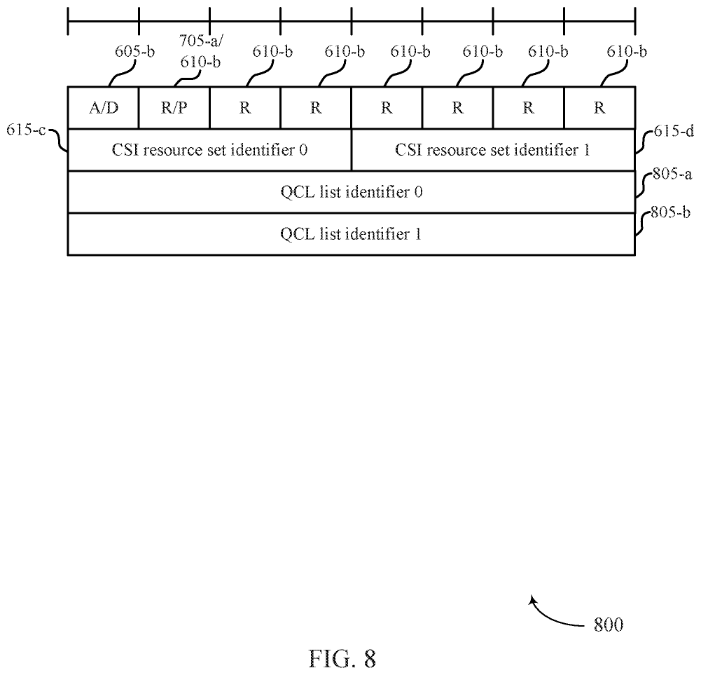

FIG. 8 illustrates an example of a MAC CE 800 that supports techniques for activating or deactivating a semi-persistent configuration for channel state indicator resource sets in accordance with various aspects of the present disclosure. The MAC CE 800 represents an example of a MAC CE structure and signaling scheme that may be used to activate or deactivate semi-persistent configurations for CSI resource sets (e.g., CSI-RS resource sets or CSI-IM resource sets). In some cases, the MAC CE 800 may be an example of the MAC CE 205, 520, 600, 700 described with reference to FIGS. 2, 5, 6, and 7.

The MAC CE 800 is similarly embodied as the MAC CEs 600 and 700 for a number of different features. For example, the MAC CE 800 includes an indicator 605-b for activating/deactivating semi-persistent configurations, reserved bits 610-b, and CSI resource set identifiers 615-c, 615-d. The CSI resource set identifiers 615-c, 615-d may configured to identify CSI resources of many different types (e.g., CSI-RS resource sets for channel measurement, CSI-RS resource sets for intra-cell interference measurement, or CSI-IM resource sets). The MAC CE 800 may include the CSI-IM indicator 705-a and may capable of signaling CSI-IM resource sets as described with reference to FIG. 7. The MAC CE 800 may also be capable of having a fixed length or a variable length.

The MAC CE 800 may include QCL list identifiers 805 associated with each CSI resource set identifier 615 in the MAC CE 800. The QCL list identifiers 805 may identify a QCL list that is mapped to a given CSI resource set. For example, the first QCL list identifier 805-a may indicate the QCL list for the first CSI resource set identifier 615-c and the second QCL list identifier 805-b may indicate the QCL list for the second CSI resource set identifier 615-d in the MAC CE 800.

The RRC configuration message (e.g., RRC configuration message 525) may communicate the contents of the QCL lists. In this manner, a signaling scheme that uses the MAC CE 800 may use the RRC configuration message for signaling the QCL relationships themselves, but the mapping of QCL relationships to CSI resources is communicated using the MAC CE 800. If the UE 115-b has already received the QCL list information from the base station 105-b, the UE 115-b may be able to configure its resources based on just receiving the MAC CE 800 because UE 115-b can look up the previously-stored QCL relationships using the QCL list identifiers 805. This signaling scheme allows the MAC CE 800 to change the semi-persistent configuration and the QCL relationships. In some cases, the MAC CE 800 may be able to more quickly indicate changes than the MAC CEs 600 and 700 and their associated signaling schemes.

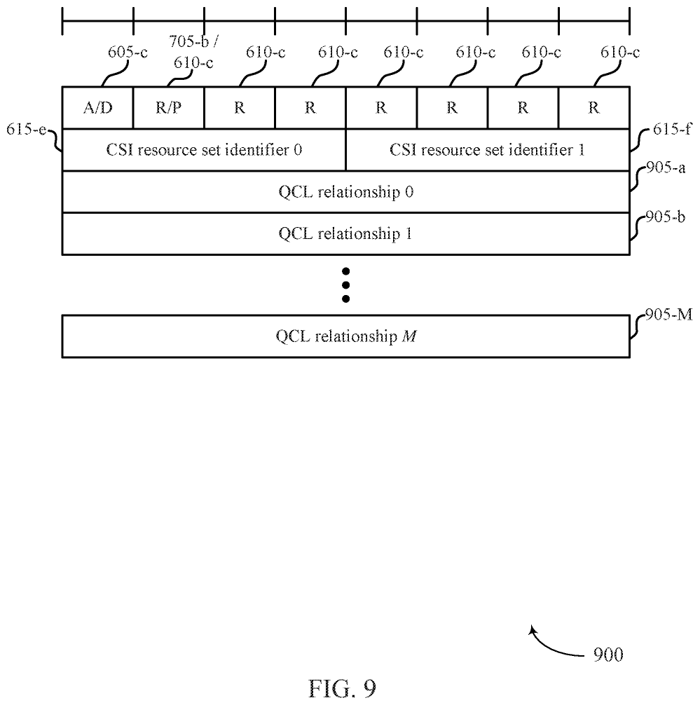

FIG. 9 illustrates an example of a MAC CE 900 that supports techniques for activating or deactivating a semi-persistent configuration for channel state indicator resource sets in accordance with various aspects of the present disclosure. The MAC CE 900 represents an example of a MAC CE structure and signaling scheme that may be used to activate or deactivate semi-persistent configurations for CSI resource sets (e.g., CSI-RS resource sets or CSI-IM resource sets). In some cases, the MAC CE 900 may be an example of the MAC CE 205, 520, 600, 700 described with reference to FIGS. 2, 5, 6, and 7.

The MAC CE 900 is similarly embodied as the MAC CEs 600 and 700 for a number of different features. For example, the MAC CE 900 includes an indicator 605-c for activating/deactivating semi-persistent configurations, reserved bits 610-c, and CSI resource set identifiers 615-e, 615-f. The CSI resource set identifiers 615-e, 615-f may configured to identify CSI resources of many different types (e.g., CSI-RS resource sets for channel measurement, CSI-RS resource sets for intra-cell interference measurement, or CSI-IM resource sets). The MAC CE 900 may include the CSI-IM indicator 705-b and may capable of signaling CSI-IM resource sets as described with reference to FIG. 7. The MAC CE 900 may also be capable of having a fixed length or a variable length.

The MAC CE 900 may include QCL relationships 905 associated with each CSI resource of the CSI resource sets identified in the MAC CE 900. In such situations, the RRC configuration message may not be used to communicate any information about the QCL relationships. Rather, the QCL relationships may be included in the MAC CE 900 itself. The QCL relationships 905 may include information indicating which CSI resources are associated with the QCL relationship 905. In some cases, the MAC CE 900 may become quite large depending on the number of CSI resource sets included and the number of CSI resources in each CSI resource set.

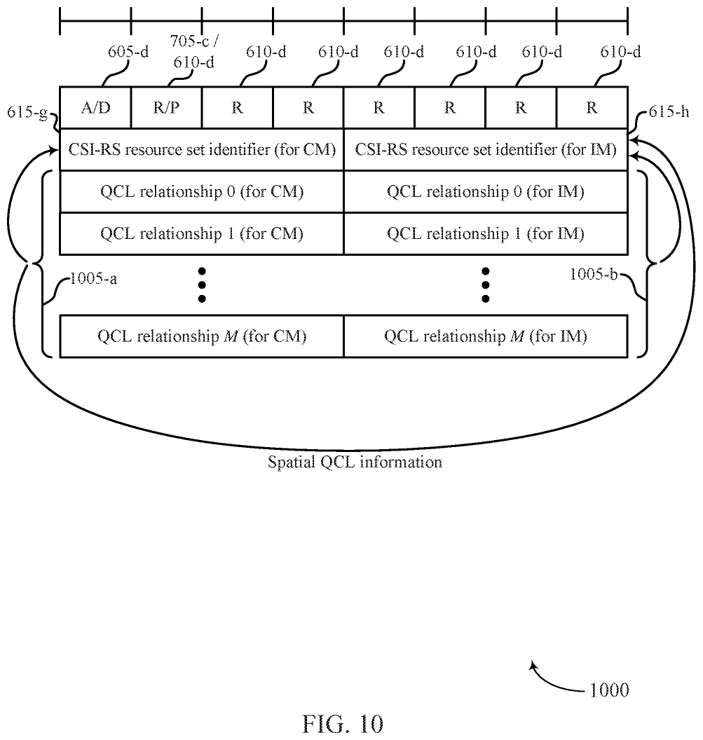

FIG. 10 illustrates an example of a MAC CE 1000 that supports techniques for activating or deactivating a semi-persistent configuration for channel state indicator resource sets in accordance with various aspects of the present disclosure. The MAC CE 1000 represents an optional feature that may be incorporated into the MAC CEs 600, 700, 800, or 900. In some cases, the MAC CE 1000 may be an example of the MAC CE 205, 520, 600, 700, 800, 900 described with reference to FIGS. 2, 5, 6, 7, 8, and 9.

The MAC CE 1000 may be similarly embodied as the MAC CE 900 for a number of different features. For example, the MAC CE 1000 includes an indicator 605-d for activating/deactivating semi-persistent configurations, reserved bits 610-d, CSI resource set identifiers 615-g, 615-h, and a plurality of QCL relationships 1005 associated with the CSI resource set identifiers. The QCL relationships 1005 may be examples of the QCL relationships 905 described with reference to FIG. 9. The CSI resource set identifiers 615-g, 615-h may configured to identify CSI resources of many different types (e.g., CSI-RS resource sets for channel measurement, CSI-RS resource sets for intra-cell interference measurement, or CSI-IM resource sets). The MAC CE 1000 may include the CSI-IM indicator 705-c and may capable of signaling CSI-IM resource sets as described with reference to FIG. 7. The MAC CE 1000 may also be capable of having a fixed length or a variable length.

The MAC CE 1000 may include a first set of QCL relationships 1005-a associated with a CSI-RS resource set identifier (for CM) 615-g and a second set of QCL relationships 1005-b associated with a CSI-RS resource set identifier (for IM) 615-h. Where the CSI-RS resource set identifier (for IM) 615-h is for intra-cell interference measurements. In some cases, at least a portion of the QCL relationships 1005-a associated with the CSI-RS resource set identifier (for CM) 615-g may be used by the CSI-RS resource set identifier (for IM) 615-h. For example, the CSI-RS resource set identifier (for IM) 615-h may use the spatial QCL information (e.g., spatial reception parameters such as beam direction and/or beam width) from the QCL relationships 1005-a and may use the remaining portions of the QCL information (e.g., Doppler shift/spread, average delay, delay spread, timing) from the QCL relationships 1005-b.

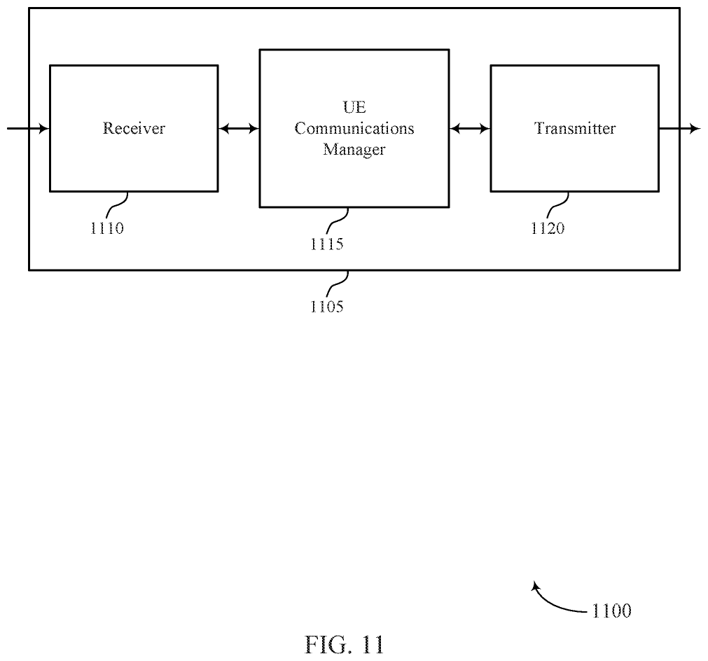

FIG. 11 shows a block diagram 1100 of a wireless device 1105 that supports techniques for activating or deactivating a semi-persistent configuration for channel state indicator resource sets in accordance with aspects of the present disclosure. Wireless device 1105 may be an example of aspects of a UE 115 as described herein. Wireless device 1105 may include receiver 1110, UE communications manager 1115, and transmitter 1120. Wireless device 1105 may also include a processor. Each of these components may be in communication with one another (e.g., via one or more buses).

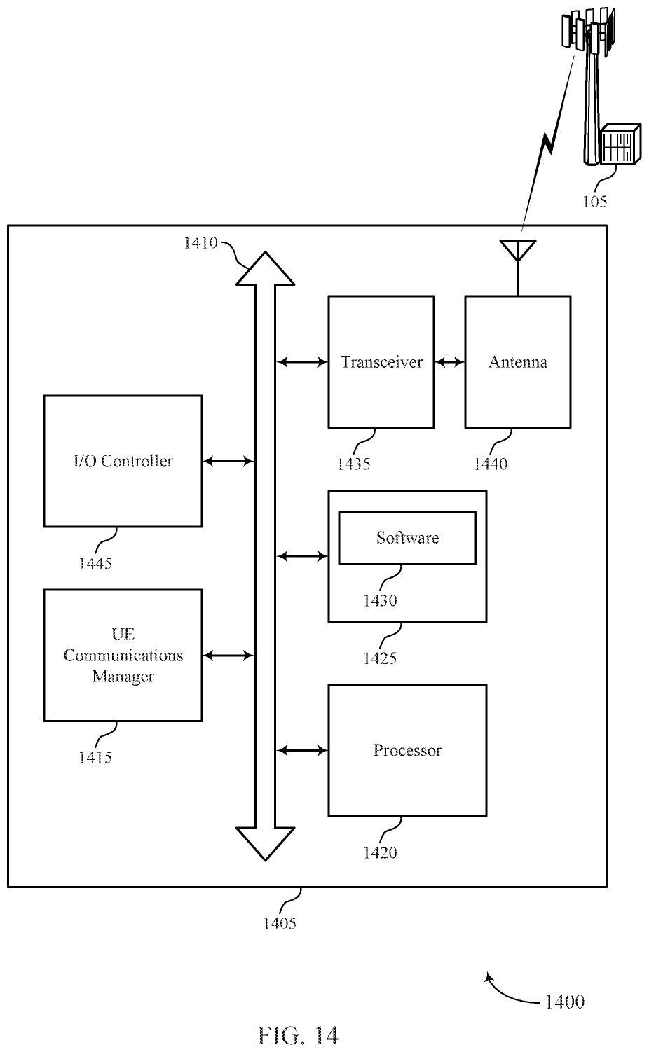

Receiver 1110 may receive information such as packets, user data, or control information associated with various information channels (e.g., control channels, data channels, and information related to techniques for activating or deactivating a semi-persistent configuration for channel state indicator resource sets, etc.). Information may be passed on to other components of the device. The receiver 1110 may be an example of aspects of the transceiver 1435 described with reference to FIG. 14. The receiver 1110 may utilize a single antenna or a set of antennas.

UE communications manager 1115 may be an example of aspects of the UE communications manager 1415 described with reference to FIG. 14. UE communications manager 1115 and/or at least some of its various sub-components may be implemented in hardware, software executed by a processor, firmware, or any combination thereof. If implemented in software executed by a processor, the functions of the UE communications manager 1115 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The UE communications manager 1115 and/or at least some of its various sub-components may be physically located at various positions, including being distributed such that portions of functions are implemented at different physical locations by one or more physical devices. In some examples, UE communications manager 1115 and/or at least some of its various sub-components may be a separate and distinct component in accordance with various aspects of the present disclosure. In other examples, UE communications manager 1115 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

UE communications manager 1115 may receive a MAC CE that includes an indicator for activating or deactivating a semi-persistent configuration of one or more CSI-RS resource sets, identify a CSI-RS resource set to activate or deactivate in the semi-persistent configuration based on receiving the MAC CE, the CSI-RS resource set including one or more CSI-RS resources, determine one or more QCL relationships mapped to the one or more CSI-RS resources in the CSI-RS resource set, and monitor the one or more CSI-RS resources of the CSI-RS resource set based on identifying the CSI-RS resource set and determining the one or more QCL relationships for each CSI-RS resource.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1435 described with reference to FIG. 14. The transmitter 1120 may utilize a single antenna or a set of antennas.

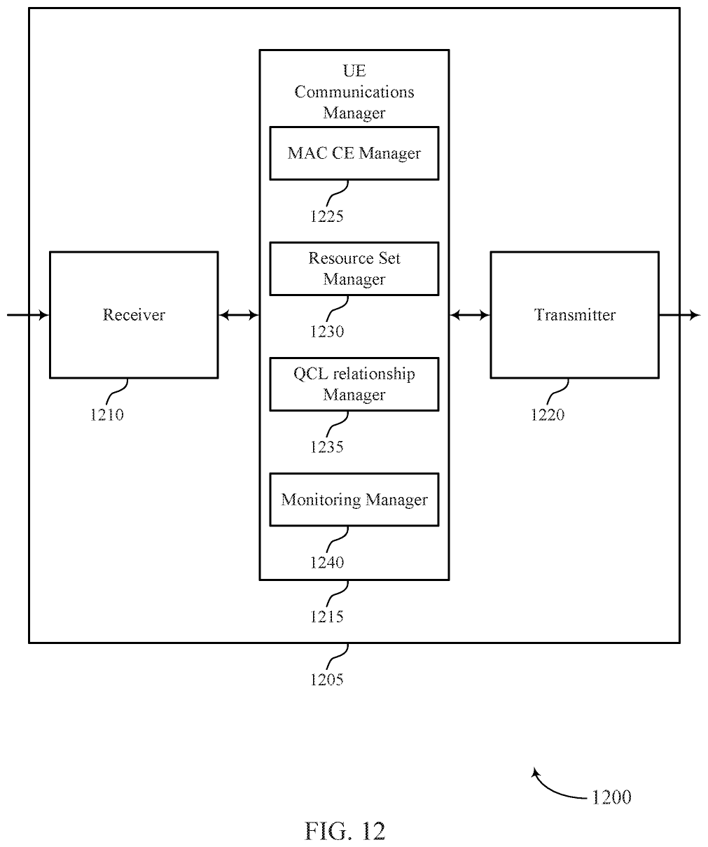

FIG. 12 shows a block diagram 1200 of a wireless device 1205 that supports techniques for activating or deactivating a semi-persistent configuration for channel state indicator resource sets in accordance with aspects of the present disclosure. Wireless device 1205 may be an example of aspects of a wireless device 1105 or a UE 115 as described with reference to FIG. 11. Wireless device 1205 may include receiver 1210, UE communications manager 1215, and transmitter 1220. Wireless device 1205 may also include a processor. Each of these components may be in communication with one another (e.g., via one or more buses).

Receiver 1210 may receive information such as packets, user data, or control information associated with various information channels (e.g., control channels, data channels, and information related to techniques for activating or deactivating a semi-persistent configuration for channel state indicator resource sets, etc.). Information may be passed on to other components of the device. The receiver 1210 may be an example of aspects of the transceiver 1435 described with reference to FIG. 14. The receiver 1210 may utilize a single antenna or a set of antennas.

UE communications manager 1215 may be an example of aspects of the UE communications manager 1415 described with reference to FIG. 14. UE communications manager 1215 may also include MAC CE manager 1225, resource set manager 1230, QCL relationship manager 1235, and monitoring manager 1240.

MAC CE manager 1225 may receive a MAC CE that includes an indicator for activating or deactivating a semi-persistent configuration of one or more CSI-RS resource sets. In some cases, the MAC CE includes an identifier for the CSI-RS resource set. In some cases, the MAC CE includes the one or more QCL relationships for the one or more CSI-RS resources of the CSI-RS resource set that is activated or deactivated in the semi-persistent configuration, where determining the one or more QCL relationships is based on receiving the MAC CE. In some cases, the MAC CE has a fixed size and includes a first identifier for one CSI-RS resource set. In some cases, the MAC CE that has the fixed size includes a second identifier for one CSI-IM resource set. In some cases, the MAC CE has a variable size and includes one or more first identifiers for one or more CSI-RS resource sets. In some cases, the MAC CE that has the variable size includes a second identifier for one CSI-IM resource set. In some cases, the indicator that activates or deactivates the semi-persistent configuration includes one bit of the MAC CE. In some cases, the MAC CE includes an identifier for a CSI-RS resource set for channel measurement and an identifier for a CSI-RS for intra-cell interference measurement resource set, where the CSI-RS resource set for intra-cell interference measurement is monitored using spatial QCL relationships associated with the CSI-RS resource set for channel measurement and other QCL relationships associated with the CSI-RS resource set for intra-cell interference measurement. In some cases, the MAC CE includes an identifier for a CSI-RS resource set for CM, an identifier for a CSI-IM, one or more identifiers for one or more CSI-RS resource sets for IM, or a combination thereof.

Resource set manager 1230 may identify a CSI-RS resource set to activate or deactivate in the semi-persistent configuration based on receiving the MAC CE, the CSI-RS resource set including one or more CSI-RS resources.

QCL relationship manager 1235 may determine one or more QCL relationships mapped to the one or more CSI-RS resources in the CSI-RS resource set.

Monitoring manager 1240 may monitor the one or more CSI-RS resources of the CSI-RS resource set based on identifying the CSI-RS resource set and determining the one or more QCL relationships for each CSI-RS resource.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1435 described with reference to FIG. 14. The transmitter 1220 may utilize a single antenna or a set of antennas.

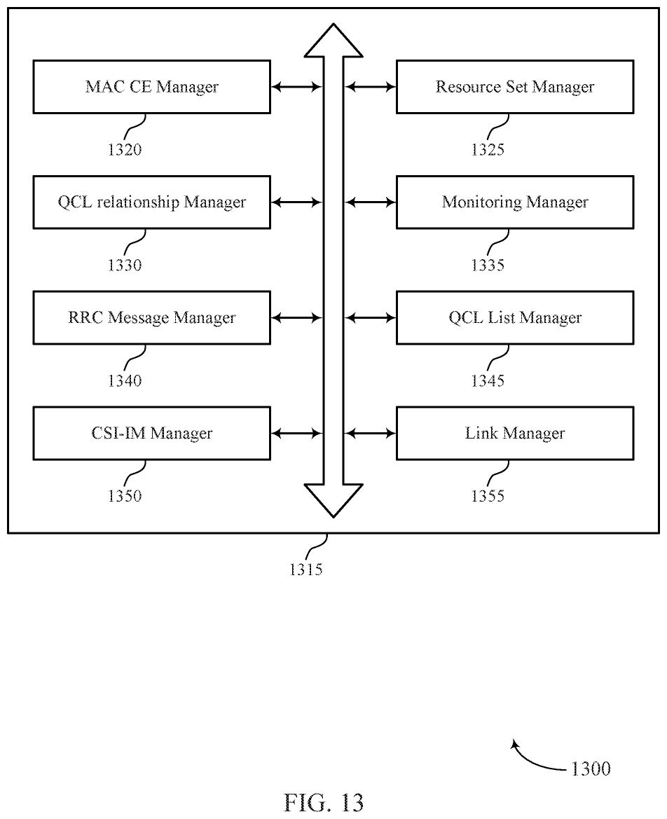

FIG. 13 shows a block diagram 1300 of a UE communications manager 1315 that supports techniques for activating or deactivating a semi-persistent configuration for channel state indicator resource sets in accordance with aspects of the present disclosure. The UE communications manager 1315 may be an example of aspects of a UE communications manager 1115, a UE communications manager 1215, or a UE communications manager 1415 described with reference to FIGS. 11, 12, and 14. The UE communications manager 1315 may include MAC CE manager 1320, resource set manager 1325, QCL relationship manager 1330, monitoring manager 1335, RRC message manager 1340, QCL list manager 1345, CSI-IM manager 1350, and link manager 1355. Each of these modules may communicate, directly or indirectly, with one another (e.g., via one or more buses).

MAC CE manager 1320 may receive a MAC CE that includes an indicator for activating or deactivating a semi-persistent configuration of one or more CSI-RS resource sets. In some cases, the MAC CE includes an identifier for the CSI-RS resource set. In some cases, the MAC CE includes the one or more QCL relationships for the one or more CSI-RS resources of the CSI-RS resource set that is activated or deactivated in the semi-persistent configuration, where determining the one or more QCL relationships is based on receiving the MAC CE. In some cases, the MAC CE has a fixed size and includes a first identifier for one CSI-RS resource set. In some cases, the MAC CE that has the fixed size includes a second identifier for one CSI-IM resource set. In some cases, the MAC CE has a variable size and includes one or more first identifiers for one or more CSI-RS resource sets. In some cases, the MAC CE that has the variable size includes a second identifier for one CSI-IM resource set. In some cases, the indicator that activates or deactivates the semi-persistent configuration includes one bit of the MAC CE. In some cases, the MAC CE includes an identifier for a CSI-RS resource set for channel measurement and an identifier for a CSI-RS for intra-cell interference measurement resource set, where the CSI-RS resource set for intra-cell interference measurement is monitored using spatial QCL relationships associated with the CSI-RS resource set for channel measurement and other QCL relationships associated with the CSI-RS resource set for intra-cell interference measurement. In some cases, the MAC CE includes an identifier for a CSI-RS resource set for CM, an identifier for a CSI-IM, one or more identifiers for one or more CSI-RS resource sets for IM, or a combination thereof.

Resource set manager 1325 may identify a CSI-RS resource set to activate or deactivate in the semi-persistent configuration based on receiving the MAC CE, the CSI-RS resource set including one or more CSI-RS resources.

QCL relationship manager 1330 may determine one or more QCL relationships mapped to the one or more CSI-RS resources in the CSI-RS resource set.

Monitoring manager 1335 may monitor the one or more CSI-RS resources of the CSI-RS resource set based on identifying the CSI-RS resource set and determining the one or more QCL relationships for each CSI-RS resource.

RRC message manager 1340 may receive a RRC configuration message that includes the one or more QCL relationships for each of the one or more CSI-RS resources, where determining the one or more QCL relationships is based on receiving the RRC configuration message. In some cases, the RRC configuration message includes at least one QCL list that includes the one or more QCL relationships mapped to the one or more CSI-RS resources of the CSI-RS resource set.

QCL list manager 1345 may identify a QCL list identifier in the MAC CE, the QCL list identifier specifying a QCL list associated with the CSI-RS resource set activated or deactivated in the semi-persistent configuration, where determining the one or more QCL relationships is based on identifying the QCL list identifier in the MAC CE and receive a RRC configuration message that includes a set of QCL lists that includes the QCL list identified in the MAC CE, each list including a mapping of QCL relationships to CSI-RS resources, where determining the one or more QCL relationships is based on receiving the RRC configuration message.

CSI-IM manager 1350 may determine whether the MAC CE includes an identifier for a CSI-IM resource set based on a second indicator in the MAC CE that specifies whether the MAC CE includes the identifier for the CSI-IM resource set. In some cases, the second indicator that specifies whether the MAC CE includes the identifier for the CSI-IM resource set includes one bit of the MAC CE.

Link manager 1355 may receive a second MAC CE that includes a second indicator that activates or deactivates the semi-persistent configuration of a CSI-IM resource set, where monitoring the one or more CSI-RS resources is based on receiving the second MAC CE.

FIG. 14 shows a diagram of a system 1400 including a device 1405 that supports techniques for activating or deactivating a semi-persistent configuration for channel state indicator resource sets in accordance with aspects of the present disclosure. Device 1405 may be an example of or include the components of wireless device 1105, wireless device 1205, or a UE 115 as described above, e.g., with reference to FIGS. 11 and 12. Device 1405 may include components for bi-directional voice and data communications including components for transmitting and receiving communications, including UE communications manager 1415, processor 1420, memory 1425, software 1430, transceiver 1435, antenna 1440, and I/O controller 1445. These components may be in electronic communication via one or more buses (e.g., bus 1410). Device 1405 may communicate wirelessly with one or more base stations 105.

Processor 1420 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1420 may be configured to operate a memory array using a memory controller. In other cases, a memory controller may be integrated into processor 1420. Processor 1420 may be configured to execute computer-readable instructions stored in a memory to perform various functions (e.g., functions or tasks supporting techniques for activating or deactivating a semi-persistent configuration for channel state indicator resource sets).

Memory 1425 may include random access memory (RAM) and read only memory (ROM). The memory 1425 may store computer-readable, computer-executable software 1430 including instructions that, when executed, cause the processor to perform various functions described herein. In some cases, the memory 1425 may contain, among other things, a basic input/output system (BIOS) which may control basic hardware or software operation such as the interaction with peripheral components or devices.

Software 1430 may include code to implement aspects of the present disclosure, including code to support techniques for activating or deactivating a semi-persistent configuration for channel state indicator resource sets. Software 1430 may be stored in a non-transitory computer-readable medium such as system memory or other memory. In some cases, the software 1430 may not be directly executable by the processor but may cause a computer (e.g., when compiled and executed) to perform functions described herein.

Transceiver 1435 may communicate bi-directionally, via one or more antennas, wired, or wireless links as described above. For example, the transceiver 1435 may represent a wireless transceiver and may communicate bi-directionally with another wireless transceiver. The transceiver 1435 may also include a modem to modulate the packets and provide the modulated packets to the antennas for transmission, and to demodulate packets received from the antennas. In some cases, the device 1405 may include a single antenna 1440. However, in some cases the device 1405 may have more than one antenna 1440, which may be capable of concurrently transmitting or receiving multiple wireless transmissions.

I/O controller 1445 may manage input and output signals for device 1405. I/O controller 1445 may also manage peripherals not integrated into device 1405. In some cases, I/O controller 1445 may represent a physical connection or port to an external peripheral. In some cases, I/O controller 1445 may utilize an operating system such as iOS®, ANDROID®, MS-DOS®, MS-WINDOWS®, OS/2®, UNIX®, LINUX®, or another known operating system. In other cases, I/O controller 1445 may represent or interact with a modem, a keyboard, a mouse, a touchscreen, or a similar device. In some cases, I/O controller 1445 may be implemented as part of a processor. In some cases, a user may interact with device 1405 via I/O controller 1445 or via hardware components controlled by I/O controller 1445.

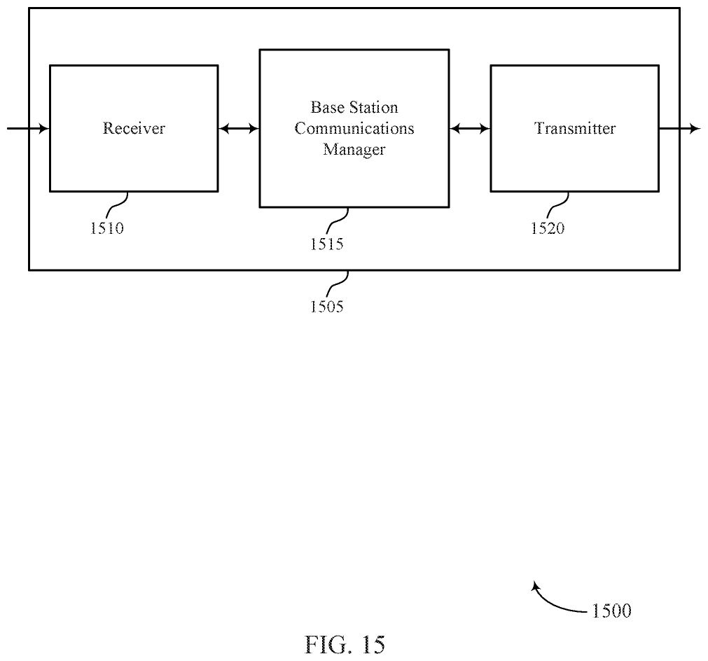

FIG. 15 shows a block diagram 1500 of a wireless device 1505 that supports techniques for activating or deactivating a semi-persistent configuration for channel state indicator resource sets in accordance with aspects of the present disclosure. Wireless device 1505 may be an example of aspects of a base station 105 as described herein. Wireless device 1505 may include receiver 1510, base station communications manager 1515, and transmitter 1520. Wireless device 1505 may also include a processor. Each of these components may be in communication with one another (e.g., via one or more buses).

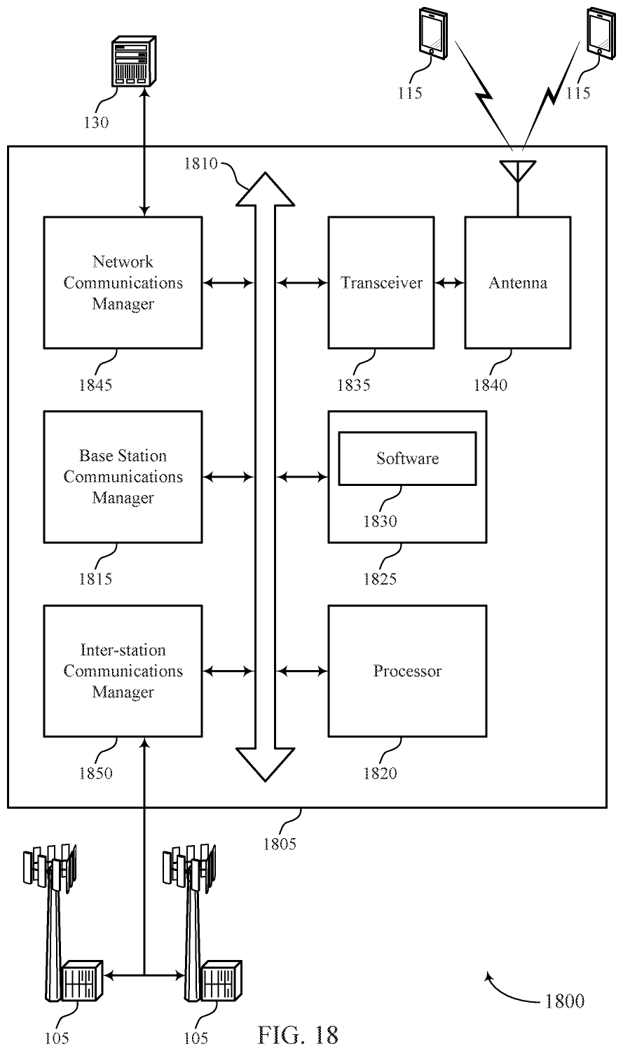

Receiver 1510 may receive information such as packets, user data, or control information associated with various information channels (e.g., control channels, data channels, and information related to techniques for activating or deactivating a semi-persistent configuration for channel state indicator resource sets, etc.). Information may be passed on to other components of the device. The receiver 1510 may be an example of aspects of the transceiver 1835 described with reference to FIG. 18. The receiver 1510 may utilize a single antenna or a set of antennas.

Base station communications manager 1515 may be an example of aspects of the base station communications manager 1815 described with reference to FIG. 18. Base station communications manager 1515 and/or at least some of its various sub-components may be implemented in hardware, software executed by a processor, firmware, or any combination thereof. If implemented in software executed by a processor, the functions of the base station communications manager 1515 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The base station communications manager 1515 and/or at least some of its various sub-components may be physically located at various positions, including being distributed such that portions of functions are implemented at different physical locations by one or more physical devices. In some examples, base station communications manager 1515 and/or at least some of its various sub-components may be a separate and distinct component in accordance with various aspects of the present disclosure. In other examples, base station communications manager 1515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Base station communications manager 1515 may identify a CSI-RS resource set to activate or deactivate in a semi-persistent configuration, the CSI-RS resource set including one or more CSI-RS resources, determine one or more QCL relationships for the one or more CSI-RS resources in the CSI-RS resource set, and transmit a MAC CE that includes an indicator for activating or deactivating the semi-persistent configuration of the CSI-RS resource set at a UE.

Transmitter 1520 may transmit signals generated by other components of the device. In some examples, the transmitter 1520 may be collocated with a receiver 1510 in a transceiver module. For example, the transmitter 1520 may be an example of aspects of the transceiver 1835 described with reference to FIG. 18. The transmitter 1520 may utilize a single antenna or a set of antennas.

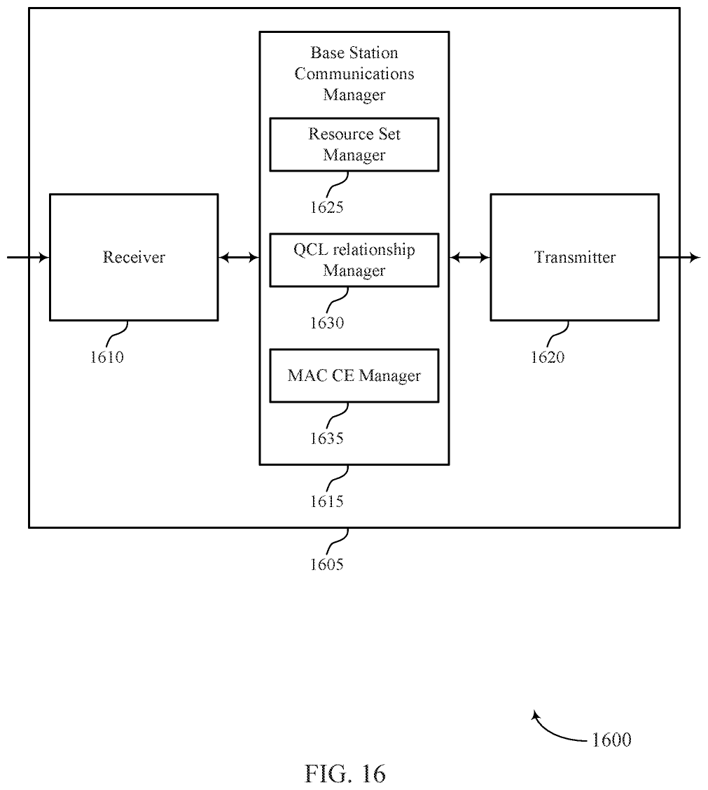

FIG. 16 shows a block diagram 1600 of a wireless device 1605 that supports techniques for activating or deactivating a semi-persistent configuration for channel state indicator resource sets in accordance with aspects of the present disclosure. Wireless device 1605 may be an example of aspects of a wireless device 1505 or a base station 105 as described with reference to FIG. 15. Wireless device 1605 may include receiver 1610, base station communications manager 1615, and transmitter 1620. Wireless device 1605 may also include a processor. Each of these components may be in communication with one another (e.g., via one or more buses).

Receiver 1610 may receive information such as packets, user data, or control information associated with various information channels (e.g., control channels, data channels, and information related to techniques for activating or deactivating a semi-persistent configuration for channel state indicator resource sets, etc.). Information may be passed on to other components of the device. The receiver 1610 may be an example of aspects of the transceiver 1835 described with reference to FIG. 18. The receiver 1610 may utilize a single antenna or a set of antennas.

Base station communications manager 1615 may be an example of aspects of the base station communications manager 1815 described with reference to FIG. 18. Base station communications manager 1615 may also include resource set manager 1625, QCL relationship manager 1630, and MAC CE manager 1635.

Resource set manager 1625 may identify a CSI-RS resource set to activate or deactivate in a semi-persistent configuration, the CSI-RS resource set including one or more CSI-RS resources.

QCL relationship manager 1630 may determine one or more QCL relationships for the one or more CSI-RS resources in the CSI-RS resource set and transmit a RRC configuration message that includes a set of QCL lists that includes the QCL list identified in the MAC CE, each list including a mapping of QCL relationships to CSI-RS resources.

MAC CE manager 1635 may transmit a MAC CE that includes an indicator for activating or deactivating the semi-persistent configuration of the CSI-RS resource set at a UE. In some cases, the MAC CE includes an identifier for a CSI-RS resource set for CM, an identifier for a CSI-IM, one or more identifiers for one or more CSI-RS resource sets for IM, or a combination thereof. In some cases, the MAC CE includes the one or more QCL relationships for the one or more CSI-RS resources of the CSI-RS resource set that is activated or deactivated in the semi-persistent configuration.

In some cases, the MAC CE has a fixed size and includes a first identifier for one CSI-RS resource set. In some cases, the MAC CE that has the fixed size includes a second identifier for one CSI-IM resource set. In some cases, the MAC CE has a variable size and includes one or more first identifiers for one or more CSI-RS resource sets. In some cases, the MAC CE includes an identifier for the CSI-RS resource set.

In some cases, the MAC CE includes a second indicator that specifies whether the MAC CE includes an identifier for a CSI-IM resource set. In some cases, the second indicator that specifies whether the MAC CE includes the identifier for the CSI-IM resource set includes one bit of the MAC CE. In some cases, the indicator that activates or deactivates the semi-persistent configuration includes one bit of the MAC CE. In some cases, the MAC CE includes an identifier for a CSI-RS resource set for channel measurement and an identifier for a CSI-RS for intra-cell interference measurement resource set, where the CSI-RS resource set for intra-cell interference measurement is monitored using spatial QCL relationships associated with the CSI-RS resource set for channel measurement and other QCL relationships associated with the CSI-RS resource set for intra-cell interference measurement. In some cases, the MAC CE that has the variable size includes a second identifier for one CSI-IM resource set.

Transmitter 1620 may transmit signals generated by other components of the device. In some examples, the transmitter 1620 may be collocated with a receiver 1610 in a transceiver module. For example, the transmitter 1620 may be an example of aspects of the transceiver 1835 described with reference to FIG. 18. The transmitter 1620 may utilize a single antenna or a set of antennas.

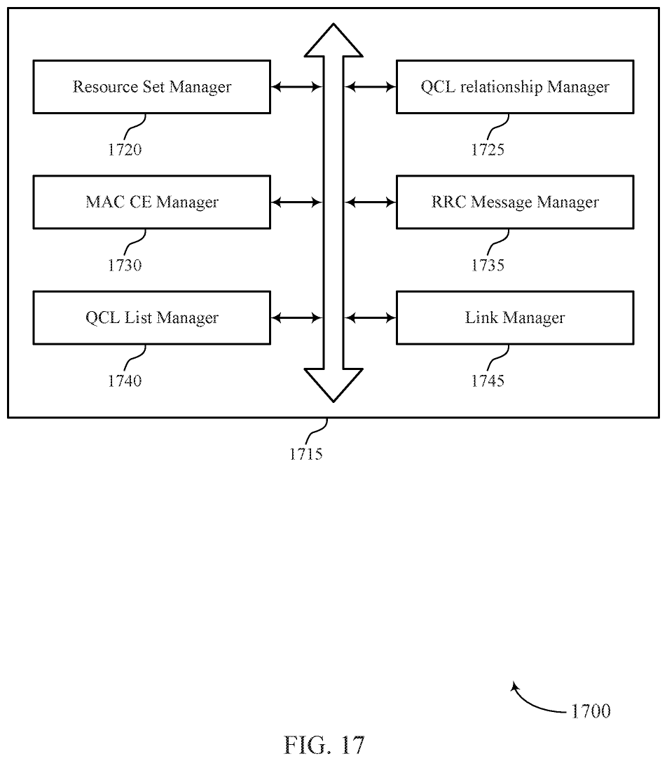

FIG. 17 shows a block diagram 1700 of a base station communications manager 1715 that supports techniques for activating or deactivating a semi-persistent configuration for channel state indicator resource sets in accordance with aspects of the present disclosure. The base station communications manager 1715 may be an example of aspects of a base station communications manager 1815 described with reference to FIGS. 15, 16, and 18. The base station communications manager 1715 may include resource set manager 1720, QCL relationship manager 1725, MAC CE manager 1730, RRC message manager 1735, QCL list manager 1740, and link manager 1745. Each of these modules may communicate, directly or indirectly, with one another (e.g., via one or more buses).

Resource set manager 1720 may identify a CSI-RS resource set to activate or deactivate in a semi-persistent configuration, the CSI-RS resource set including one or more CSI-RS resources.

QCL relationship manager 1725 may determine one or more QCL relationships for the one or more CSI-RS resources in the CSI-RS resource set and transmit a RRC configuration message that includes a set of QCL lists that includes the QCL list identified in the MAC CE, each list including a mapping of QCL relationships to CSI-RS resources.

MAC CE manager 1730 may transmit a MAC CE that includes an indicator for activating or deactivating the semi-persistent configuration of the CSI-RS resource set at a UE. In some cases, the MAC CE includes an identifier for a CSI-RS resource set for CM, an identifier for a CSI-IM, one or more identifiers for one or more CSI-RS resource sets for intra-cell IM, or a combination thereof. In some cases, the MAC CE includes the one or more QCL relationships for the one or more CSI-RS resources of the CSI-RS resource set that is activated or deactivated in the semi-persistent configuration.

In some cases, the MAC CE has a fixed size and includes a first identifier for one CSI-RS resource set. In some cases, the MAC CE that has the fixed size includes a second identifier for one CSI-IM resource set. In some cases, the MAC CE has a variable size and includes one or more first identifiers for one or more CSI-RS resource sets. In some cases, the MAC CE includes an identifier for the CSI-RS resource set. In some cases, the MAC CE includes a second indicator that specifies whether the MAC CE includes an identifier for a CSI-IM resource set. In some cases, the second indicator that specifies whether the MAC CE includes the identifier for the CSI-IM resource set includes one bit of the MAC CE. In some cases, the indicator that activates or deactivates the semi-persistent configuration includes one bit of the MAC CE.

In some cases, the MAC CE includes an identifier for a CSI-RS resource set for channel measurement and an identifier for a CSI-RS for intra-cell interference measurement resource set, where the CSI-RS resource set for intra-cell interference measurement is monitored using spatial QCL relationships associated with the CSI-RS resource set for channel measurement and other QCL relationships associated with the CSI-RS resource set for intra-cell interference measurement. In some cases, the MAC CE that has the variable size includes a second identifier for one CSI-IM resource set.

RRC message manager 1735 may transmit a RRC configuration message that includes the one or more QCL relationships for each of the one or more CSI-RS resources. In some cases, the RRC configuration message includes at least one QCL list that includes the one or more QCL relationships mapped to the one or more CSI-RS resources of the CSI-RS resource set.

QCL list manager 1740 may identify a QCL list identifier of the one or more QCL relationships, the QCL list identifier specifying a QCL list associated with the CSI-RS resource set that is activated or deactivated in the semi-persistent configuration, where the MAC CE includes the QCL list identifier.

Link manager 1745 may transmit a second MAC CE that includes a second indicator that activates or deactivates the semi-persistent configuration of a CSI-IM resource set.

FIG. 18 shows a diagram of a system 1800 including a device 1805 that supports techniques for activating or deactivating a semi-persistent configuration for channel state indicator resource sets in accordance with aspects of the present disclosure. Device 1805 may be an example of or include the components of base station 105 as described above, e.g., with reference to FIG. 1. Device 1805 may include components for bi-directional voice and data communications including components for transmitting and receiving communications, including base station communications manager 1815, processor 1820, memory 1825, software 1830, transceiver 1835, antenna 1840, network communications manager 1845, and inter-station communications manager 1850. These components may be in electronic communication via one or more buses (e.g., bus 1810). Device 1805 may communicate wirelessly with one or more UEs 115.

Processor 1820 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1820 may be configured to operate a memory array using a memory controller. In other cases, a memory controller may be integrated into processor 1820. Processor 1820 may be configured to execute computer-readable instructions stored in a memory to perform various functions (e.g., functions or tasks supporting techniques for activating or deactivating a semi-persistent configuration for channel state indicator resource sets).

Memory 1825 may include RAM and ROM. The memory 1825 may store computer-readable, computer-executable software 1830 including instructions that, when executed, cause the processor to perform various functions described herein. In some cases, the memory 1825 may contain, among other things, a BIOS which may control basic hardware or software operation such as the interaction with peripheral components or devices.

Software 1830 may include code to implement aspects of the present disclosure, including code to support techniques for activating or deactivating a semi-persistent configuration for channel state indicator resource sets. Software 1830 may be stored in a non-transitory computer-readable medium such as system memory or other memory. In some cases, the software 1830 may not be directly executable by the processor but may cause a computer (e.g., when compiled and executed) to perform functions described herein.

Transceiver 1835 may communicate bi-directionally, via one or more antennas, wired, or wireless links as described above. For example, the transceiver 1835 may represent a wireless transceiver and may communicate bi-directionally with another wireless transceiver. The transceiver 1835 may also include a modem to modulate the packets and provide the modulated packets to the antennas for transmission, and to demodulate packets received from the antennas. In some cases, the device 1805 may include a single antenna 1840. However, in some cases the device 1805 may have more than one antenna 1840, which may be capable of concurrently transmitting or receiving multiple wireless transmissions.

Network communications manager 1845 may manage communications with the core network (e.g., via one or more wired backhaul links). For example, the network communications manager 1845 may manage the transfer of data communications for client devices, such as one or more UEs 115.

Inter-station communications manager 1850 may manage communications with other base station 105, and may include a controller or scheduler for controlling communications with UEs 115 in cooperation with other base stations 105. For example, the inter-station communications manager 1850 may coordinate scheduling for transmissions to UEs 115 for various interference mitigation techniques such as beamforming or joint transmission. In some examples, inter-station communications manager 1850 may provide an X2 interface within an Long Term Evolution (LTE)/LTE-A wireless communication network technology to provide communication between base stations 105.

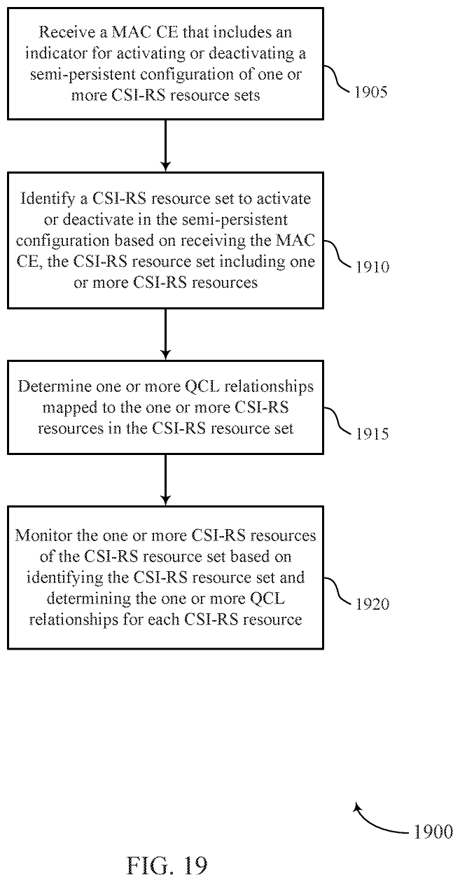

FIG. 19 shows a flowchart illustrating a method 1900 for techniques for activating or deactivating a semi-persistent configuration for channel state indicator resource sets in accordance with aspects of the present disclosure. The operations of method 1900 may be implemented by a UE 115 or its components as described herein. For example, the operations of method 1900 may be performed by a UE communications manager as described with reference to FIGS. 11 through 14. In some examples, a UE 115 may execute a set of codes to control the functional elements of the device to perform the functions described below. Additionally or alternatively, the UE 115 may perform aspects of the functions described below using special-purpose hardware.

At 1905 the UE 115 may receive a MAC CE that includes an indicator for activating or deactivating a semi-persistent configuration of one or more CSI-RS resource sets. The operations of 1905 may be performed according to the methods described herein. In certain examples, aspects of the operations of 1905 may be performed by a MAC CE manager as described with reference to FIGS. 11 through 14.

At 1910 the UE 115 may identify a CSI-RS resource set to activate or deactivate in the semi-persistent configuration based on receiving the MAC CE, the CSI-RS resource set comprising one or more CSI-RS resources. The operations of 1910 may be performed according to the methods described herein. In certain examples, aspects of the operations of 1910 may be performed by a resource set manager as described with reference to FIGS. 11 through 14.

At 1915 the UE 115 may determine one or more QCL relationships mapped to the one or more CSI-RS resources in the CSI-RS resource set. The operations of 1915 may be performed according to the methods described herein. In certain examples, aspects of the operations of 1915 may be performed by a QCL relationship manager as described with reference to FIGS. 11 through 14.

At 1920 the UE 115 may monitor the one or more CSI-RS resources of the CSI-RS resource set based on identifying the CSI-RS resource set and determining the one or more QCL relationships for each CSI-RS resource. The operations of 1920 may be performed according to the methods described herein. In certain examples, aspects of the operations of 1920 may be performed by a monitoring manager as described with reference to FIGS. 11 through 14.

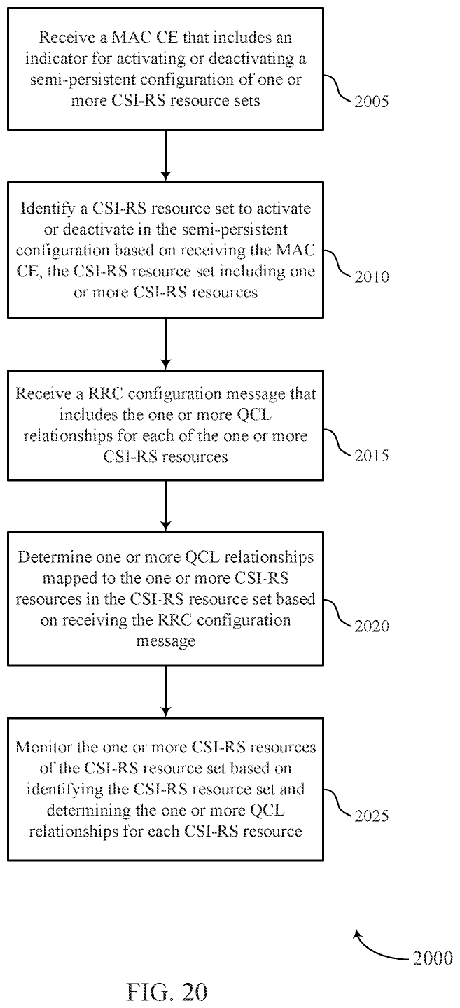

FIG. 20 shows a flowchart illustrating a method 2000 for techniques for activating or deactivating a semi-persistent configuration for channel state indicator resource sets in accordance with aspects of the present disclosure. The operations of method 2000 may be implemented by a UE 115 or its components as described herein. For example, the operations of method 2000 may be performed by a UE communications manager as described with reference to FIGS. 11 through 14. In some examples, a UE 115 may execute a set of codes to control the functional elements of the device to perform the functions described below. Additionally or alternatively, the UE 115 may perform aspects of the functions described below using special-purpose hardware.

At 2005 the UE 115 may receive a MAC CE that includes an indicator for activating or deactivating a semi-persistent configuration of one or more CSI-RS resource sets. The operations of 2005 may be performed according to the methods described herein. In certain examples, aspects of the operations of 2005 may be performed by a MAC CE manager as described with reference to FIGS. 11 through 14.

At 2010 the UE 115 may identify a CSI-RS resource set to activate or deactivate in the semi-persistent configuration based on receiving the MAC CE, the CSI-RS resource set comprising one or more CSI-RS resources. The operations of 2010 may be performed according to the methods described herein. In certain examples, aspects of the operations of 2010 may be performed by a resource set manager as described with reference to FIGS. 11 through 14.

At 2015 the UE 115 may receive a RRC configuration message that includes the one or more QCL relationships for each of the one or more CSI-RS resources. The operations of 2015 may be performed according to the methods described herein. In certain examples, aspects of the operations of 2015 may be performed by a RRC message manager as described with reference to FIGS. 11 through 14.

At 2020 the UE 115 may determine one or more QCL relationships mapped to the one or more CSI-RS resources in the CSI-RS resource set based on receiving the RRC configuration message. The operations of 2020 may be performed according to the methods described herein. In certain examples, aspects of the operations of 2020 may be performed by a QCL relationship manager as described with reference to FIGS. 11 through 14.

At 2025 the UE 115 may monitor the one or more CSI-RS resources of the CSI-RS resource set based on identifying the CSI-RS resource set and determining the one or more QCL relationships for each CSI-RS resource. The operations of 2025 may be performed according to the methods described herein. In certain examples, aspects of the operations of 2025 may be performed by a monitoring manager as described with reference to FIGS. 11 through 14.

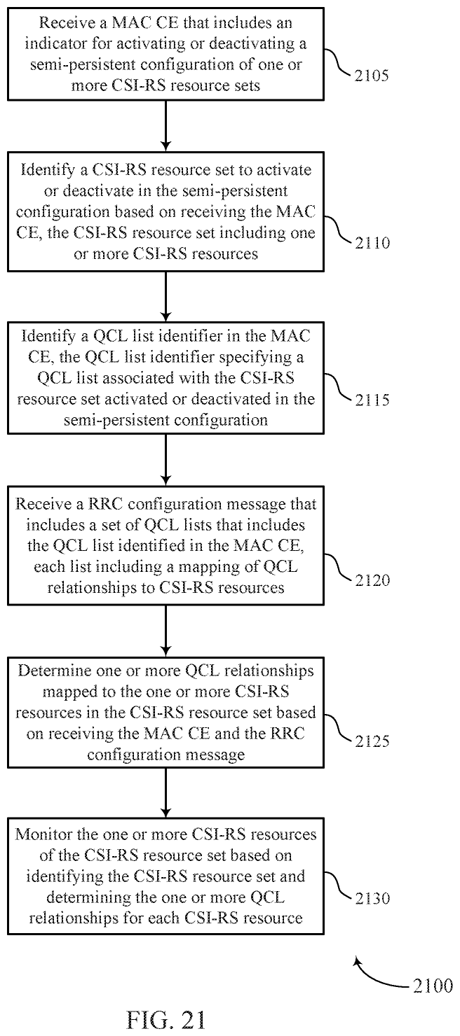

FIG. 21 shows a flowchart illustrating a method 2100 for techniques for activating or deactivating semi-persistent configuration for channel state indicator resource sets in accordance with aspects of the present disclosure. The operations of method 2100 may be implemented by a UE 115 or its components as described herein. For example, the operations of method 2100 may be performed by a UE communications manager as described with reference to FIGS. 11 through 14. In some examples, a UE 115 may execute a set of codes to control the functional elements of the device to perform the functions described below. Additionally or alternatively, the UE 115 may perform aspects of the functions described below using special-purpose hardware.

At 2105 the UE 115 may receive a MAC CE that includes an indicator for activating or deactivating a semi-persistent configuration of one or more CSI-RS resource sets. The operations of 2105 may be performed according to the methods described herein. In certain examples, aspects of the operations of 2105 may be performed by a MAC CE manager as described with reference to FIGS. 11 through 14.

At 2110 the UE 115 may identify a CSI-RS resource set to activate or deactivate in the semi-persistent configuration based on receiving the MAC CE, the CSI-RS resource set including one or more CSI-RS resources. The operations of 2110 may be performed according to the methods described herein. In certain examples, aspects of the operations of 2110 may be performed by a resource set manager as described with reference to FIGS. 11 through 14.

At 2115 the UE 115 may identify a QCL list identifier in the MAC CE, the QCL list identifier specifying a QCL list associated with the CSI-RS resource set activated or deactivated in the semi-persistent configuration. The operations of 2115 may be performed according to the methods described herein. In certain examples, aspects of the operations of 2115 may be performed by a QCL list manager as described with reference to FIGS. 11 through 14.

At 2120 the UE 115 may receive a RRC configuration message that includes a set of QCL lists that includes the QCL list identified in the MAC CE, each list including a mapping of QCL relationships to CSI-RS resources. The operations of 2120 may be performed according to the methods described herein. In certain examples, aspects of the operations of 2120 may be performed by a QCL list manager as described with reference to FIGS. 11 through 14.

At 2125 the UE 115 may determine one or more QCL relationships mapped to the one or more CSI-RS resources in the CSI-RS resource set based on receiving the MAC CE and receiving the RRC configuration message. The operations of 2125 may be performed according to the methods described herein. In certain examples, aspects of the operations of 2125 may be performed by a QCL relationship manager as described with reference to FIGS. 11 through 14.

At 2130 the UE 115 may monitor the one or more CSI-RS resources of the CSI-RS resource set based on identifying the CSI-RS resource set and determining the one or more QCL relationships for each CSI-RS resource. The operations of 2130 may be performed according to the methods described herein. In certain examples, aspects of the operations of 2130 may be performed by a monitoring manager as described with reference to FIGS. 11 through 14.

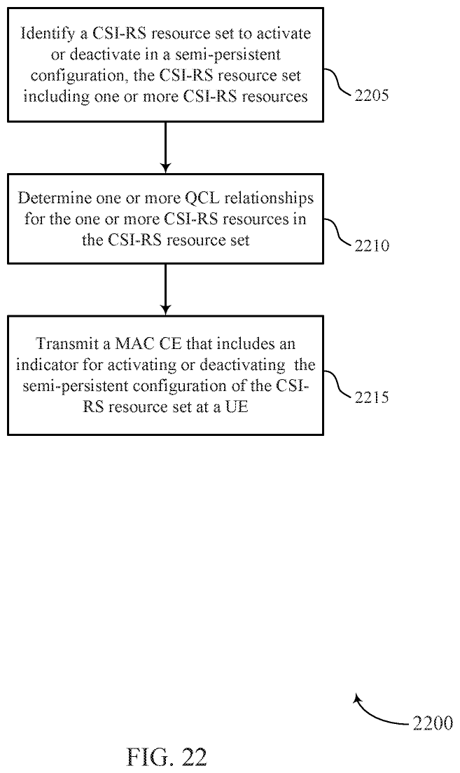

FIG. 22 shows a flowchart illustrating a method 2200 for techniques for activating or deactivating a semi-persistent configuration for channel state indicator resource sets in accordance with aspects of the present disclosure. The operations of method 2200 may be implemented by a base station 105 or its components as described herein. For example, the operations of method 2200 may be performed by a base station communications manager as described with reference to FIGS. 15 through 18. In some examples, a base station 105 may execute a set of codes to control the functional elements of the device to perform the functions described below. Additionally or alternatively, the base station 105 may perform aspects of the functions described below using special-purpose hardware.

At 2205 the base station 105 may identify a CSI-RS resource set to activate or deactivate in a semi-persistent configuration, the CSI-RS resource set including one or more CSI-RS resources. The operations of 2205 may be performed according to the methods described herein. In certain examples, aspects of the operations of 2205 may be performed by a resource set manager as described with reference to FIGS. 15 through 18.

At 2210 the base station 105 may determine one or more QCL relationships for the one or more CSI-RS resources in the CSI-RS resource set. The operations of 2210 may be performed according to the methods described herein. In certain examples, aspects of the operations of 2210 may be performed by a QCL relationship manager as described with reference to FIGS. 15 through 18.

At 2215 the base station 105 may transmit a MAC CE that includes an indicator for activating or deactivating the semi-persistent configuration of the CSI-RS resource set at a UE. The operations of 2215 may be performed according to the methods described herein. In certain examples, aspects of the operations of 2215 may be performed by a MAC CE manager as described with reference to FIGS. 15 through 18.

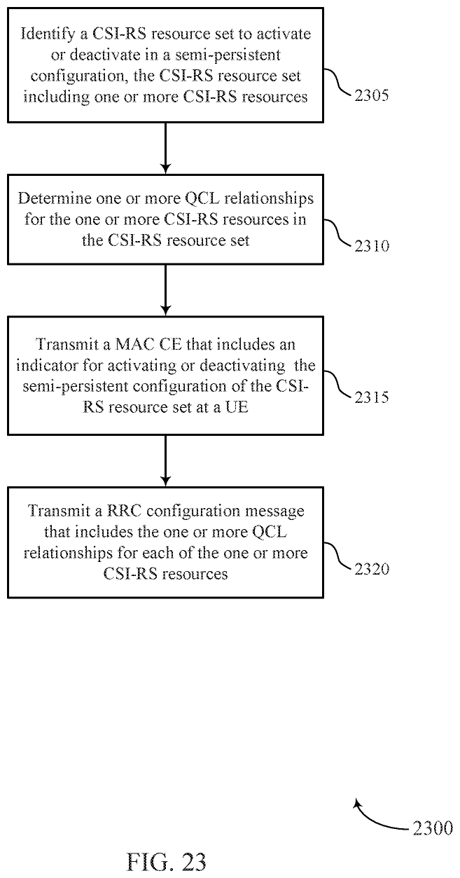

FIG. 23 shows a flowchart illustrating a method 2300 for techniques for activating or deactivating a semi-persistent configuration for channel state indicator resource sets in accordance with aspects of the present disclosure. The operations of method 2300 may be implemented by a base station 105 or its components as described herein. For example, the operations of method 2300 may be performed by a base station communications manager as described with reference to FIGS. 15 through 18. In some examples, a base station 105 may execute a set of codes to control the functional elements of the device to perform the functions described below. Additionally or alternatively, the base station 105 may perform aspects of the functions described below using special-purpose hardware.

At 2305 the base station 105 may identify a CSI-RS resource set to activate or deactivate in a semi-persistent configuration, the CSI-RS resource set including one or more CSI-RS resources. The operations of 2305 may be performed according to the methods described herein. In certain examples, aspects of the operations of 2305 may be performed by a resource set manager as described with reference to FIGS. 15 through 18.

At 2310 the base station 105 may determine one or more QCL relationships for the one or more CSI-RS resources in the CSI-RS resource set. The operations of 2310 may be performed according to the methods described herein. In certain examples, aspects of the operations of 2310 may be performed by a QCL relationship manager as described with reference to FIGS. 15 through 18.

At 2315 the base station 105 may transmit a MAC CE that includes an indicator for activating or deactivating the semi-persistent configuration of the CSI-RS resource set at a UE. The operations of 2315 may be performed according to the methods described herein. In certain examples, aspects of the operations of 2315 may be performed by a MAC CE manager as described with reference to FIGS. 15 through 18.

At 2320 the base station 105 may transmit a RRC configuration message that includes the one or more QCL relationships for each of the one or more CSI-RS resources. The operations of 2320 may be performed according to the methods described herein. In certain examples, aspects of the operations of 2320 may be performed by a RRC message manager as described with reference to FIGS. 15 through 18.

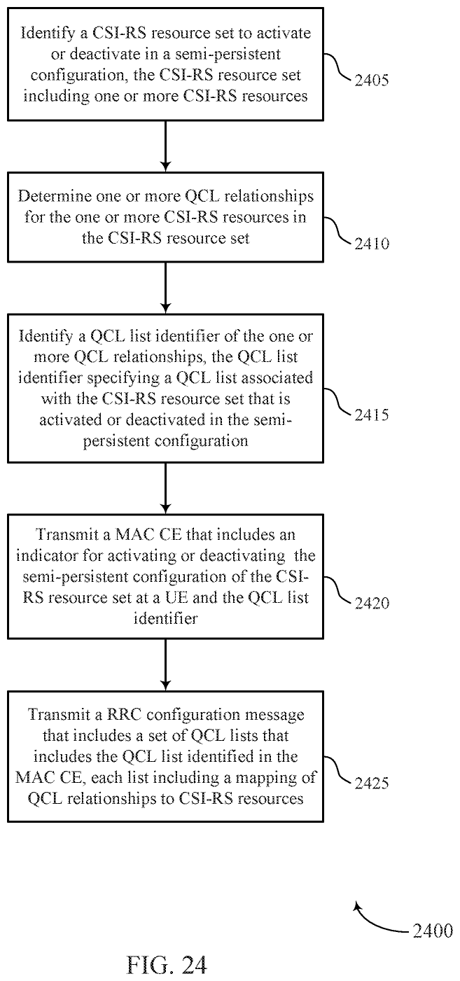

FIG. 24 shows a flowchart illustrating a method 2400 for techniques for activating or deactivating semi-persistent configuration for channel state indicator resource sets in accordance with aspects of the present disclosure. The operations of method 2400 may be implemented by a base station 105 or its components as described herein. For example, the operations of method 2400 may be performed by a base station communications manager as described with reference to FIGS. 15 through 18. In some examples, a base station 105 may execute a set of codes to control the functional elements of the device to perform the functions described below. Additionally or alternatively, the base station 105 may perform aspects of the functions described below using special-purpose hardware.

At 2405 the base station 105 may identify a CSI-RS resource set to activate or deactivate in a semi-persistent configuration, the CSI-RS resource set including one or more CSI-RS resources. The operations of 2405 may be performed according to the methods described herein. In certain examples, aspects of the operations of 2405 may be performed by a resource set manager as described with reference to FIGS. 15 through 18.

At 2410 the base station 105 may determine one or more QCL relationships for the one or more CSI-RS resources in the CSI-RS resource set. The operations of 2410 may be performed according to the methods described herein. In certain examples, aspects of the operations of 2410 may be performed by a QCL relationship manager as described with reference to FIGS. 15 through 18.

At 2415 the base station 105 may identify a QCL list identifier of the one or more QCL relationships, the QCL list identifier specifying a QCL list associated with the CSI-RS resource set that is activated or deactivated in the semi-persistent configuration. The operations of 2415 may be performed according to the methods described herein. In certain examples, aspects of the operations of 2415 may be performed by a QCL list manager as described with reference to FIGS. 15 through 18.

At 2420 the base station 105 may transmit a MAC CE that includes an indicator for activating or deactivating the semi-persistent configuration of the CSI-RS resource set at a UE and the QCL list identifier. The operations of 2420 may be performed according to the methods described herein. In certain examples, aspects of the operations of 2420 may be performed by a MAC CE manager as described with reference to FIGS. 15 through 18.

At 2425 the base station 105 may transmit a RRC configuration message that includes a set of QCL lists that includes the QCL list identified in the MAC CE, each list including a mapping of QCL relationships to CSI-RS resources. The operations of 2425 may be performed according to the methods described herein. In certain examples, aspects of the operations of 2425 may be performed by a QCL relationship manager as described with reference to FIGS. 15 through 18.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving a medium access control (MAC) control element (CE) that comprises an indicator for activating or deactivating a semi-persistent configuration of one or more channel state information reference signal (CSI-RS) resource sets;
identifying a CSI-RS resource set to activate or deactivate in the semi-persistent configuration based at least in part on receiving the MAC CE, the CSI-RS resource set comprising one or more CSI-RS resources;
determining one or more quasi-collocation (QCL) relationships mapped to the one or more CSI-RS resources in the CSI-RS resource set; and
monitoring the one or more CSI-RS resources of the CSI-RS resource set based at least in part on identifying the CSI-RS resource set and determining the one or more QCL relationships for each CSI-RS resource.

2. The method of claim 1, wherein the MAC CE comprises an identifier for the CSI-RS resource set.

3. The method of claim 1, further comprising:
receiving a radio resource control (RRC) configuration message that comprises the one or more QCL relationships for each of the one or more CSI-RS resources, wherein determining the one or more QCL relationships is based at least in part on receiving the RRC configuration message.

4. The method of claim 3, wherein the RRC configuration message comprises the one or more QCL relationships mapped to the one or more CSI-RS resources of the CSI-RS resource set.

5. The method of claim 1, wherein the MAC CE comprises the one or more QCL relationships for the one or more CSI-RS resources of the CSI-RS resource set that is activated or deactivated in the semi-persistent configuration, wherein determining the one or more QCL relationships is based at least in part on receiving the MAC CE.

6. The method of claim 1, wherein the MAC CE has a variable size and comprises one or more first identifiers for one or more CSI-RS resource sets.

7. The method of claim 6, wherein the MAC CE that has the variable size comprises a second identifier for one CSI inter-cell interference measurement (CSI-IM) resource set.

8. The method of claim 1, further comprising:
determining whether the MAC CE comprises an identifier for a CSI inter-cell interference measurement (CSI-IM) resource set based at least in part on a second indicator in the MAC CE that specifies whether the MAC CE comprises the identifier for the CSI-IM resource set.

9. The method of claim 8, wherein the second indicator that specifies whether the MAC CE includes the identifier for the CSI-IM resource set comprises one bit of the MAC CE.

10. The method of claim 1, wherein the indicator that activates or deactivates the semi-persistent configuration comprises one bit of the MAC CE.

11. The method of claim 1, wherein the MAC CE comprises an identifier for a CSI-RS resource set for channel measurement and an identifier for a CSI-RS for intra-cell interference measurement resource set, wherein the CSI-RS resource set for intra-cell interference measurement is monitored using spatial QCL relationships associated with the CSI-RS resource set for channel measurement and other QCL relationships associated with the CSI-RS resource set for intra-cell interference measurement.

12. The method of claim 1, wherein the MAC CE comprises an identifier for a CSI-RS resource set for channel measurement (CM), an identifier for a CSI inter-cell interference measurement (CSI-IM), one or more identifiers for one or more CSI-RS resource sets for intra-cell interference measurement (IM), or a combination thereof.

13. A method for wireless communication, comprising:
identifying a channel state information reference signal (CSI-RS) resource set to activate or deactivate in a semi-persistent configuration, the CSI-RS resource set comprising one or more CSI-RS resources;
determining one or more quasi-collocation (QCL) relationships for the one or more CSI-RS resources in the CSI-RS resource set; and
transmitting a medium access control (MAC) control element (CE) that comprises an indicator for activating or deactivating the semi-persistent configuration of the CSI-RS resource set at a user equipment (UE).

14. The method of claim 13, wherein the MAC CE comprises an identifier for the CSI-RS resource set.

15. The method of claim 13, further comprising:
transmitting a radio resource control (RRC) configuration message that comprises the one or more QCL relationships for each of the one or more CSI-RS resources.

16. The method of claim 15, wherein the RRC configuration message comprises the one or more QCL relationships mapped to the one or more CSI-RS resources of the CSI-RS resource set.

17. The method of claim 13, wherein the MAC CE comprises the one or more QCL relationships for the one or more CSI-RS resources of the CSI-RS resource set that is activated or deactivated in the semi-persistent configuration.

18. The method of claim 13, wherein the MAC CE has a variable size and comprises one or more first identifiers for one or more CSI-RS resource sets.

19. The method of claim 18, wherein the MAC CE that has the variable size comprises a second identifier for one CSI inter-cell interference measurement (CSI-IM) resource set.

20. The method of claim 13, wherein the MAC CE comprises a second indicator that specifies whether the MAC CE comprises an identifier for a CSI inter-cell interference measurement (CSI-IM) resource set.

21. The method of claim 20, wherein the second indicator that specifies whether the MAC CE comprises the identifier for the CSI-IM resource set comprises one bit of the MAC CE.

22. The method of claim 13, wherein the indicator that activates or deactivates the semi-persistent configuration comprises one bit of the MAC CE.

23. The method of claim 13, wherein the MAC CE comprises an identifier for a CSI-RS resource set for channel measurement and an identifier for a CSI-RS for intra-cell interference measurement resource set, wherein the CSI-RS resource set for intra-cell interference measurement is monitored using spatial QCL relationships associated with the CSI-RS resource set for channel measurement and other QCL relationships associated with the CSI-RS resource set for intra-cell interference measurement.

24. The method of claim 13, wherein the MAC CE comprises an identifier for a CSI-RS resource set for channel measurement (CM), an identifier for a CSI inter-cell interference measurement (CSI-IM), one or more identifiers for one or more CSI-RS resource sets for intra-cell interference measurement (IM), or a combination thereof.

25. An apparatus for wireless communication, comprising:
a processor;
memory in electronic communication with the processor; and
instructions stored in the memory and executable by the processor to cause the apparatus to:
receive a medium access control (MAC) control element (CE) that comprises an indicator for activating or deactivating a semi-persistent configuration of one or more channel state information reference signal (CSI-RS) resource sets;
identify a CSI-RS resource set to activate or deactivate in the semi-persistent configuration based at least in part on receiving the MAC CE, the CSI-RS resource set comprising one or more CSI-RS resources;
determine one or more quasi-collocation (QCL) relationships mapped to the one or more CSI-RS resources in the CSI-RS resource set; and
monitor the one or more CSI-RS resources of the CSI-RS resource set based at least in part on identifying the CSI-RS resource set and determining the one or more QCL relationships for each CSI-RS resource.

26. The apparatus of claim 25, wherein the MAC CE comprises an identifier for the CSI-RS resource set.

27. The apparatus of claim 25, wherein the instructions are further executable by the processor to cause the apparatus to:
receive a radio resource control (RRC) configuration message that comprises the one or more QCL relationships for each of the one or more CSI-RS resources, wherein determining the one or more QCL relationships is based at least in part on receiving the RRC configuration message.

28. An apparatus for wireless communication, comprising:
a processor;
memory in electronic communication with the processor; and
instructions stored in the memory and executable by the processor to cause the apparatus to:
identify a channel state information reference signal (CSI-RS) resource set to activate or deactivate in a semi-persistent configuration, the CSI-RS resource set comprising one or more CSI-RS resources;
determine one or more quasi-collocation (QCL) relationships for the one or more CSI-RS resources in the CSI-RS resource set; and
transmit a medium access control (MAC) control element (CE) that comprises an indicator for activating or deactivating the semi-persistent configuration of the CSI-RS resource set at a user equipment (UE).

29. The apparatus of claim 28, wherein the MAC CE comprises an identifier for the CSI-RS resource set.

30. The apparatus of claim 28, wherein the instructions are further executable by the processor to cause the apparatus to:
transmit a radio resource control (RRC) configuration message that comprises the one or more QCL relationships for each of the one or more CSI-RS resources.
